(19) United States
(12) Patent Application Publication
(10) Pub. No.: US 2023/0345479 A1
(43) Pub. Date: Oct. 26, 2023

(54) FREQUENCY-DOMAIN RESOURCE ALLOCATION FOR MULTI-CELL SCHEDULING

(71) Applicant: QUALCOMM Incorporated, San Diego, CA (US)

(72) Inventors: Kazuki Takeda, Tokyo (JP); Peter Gaal, San Diego, CA (US); Juan Montojo, San Diego, CA (US); Wanshi Chen, San Diego, CA (US); Jing Sun, San Diego, CA (US); Mostafa Khoshnevisan, San Diego, CA (US)

(21) Appl. No.: 17/726,375

(22) Filed: Apr. 21, 2022

(51) Int. Cl. H04W 72/12

(52) U.S. Cl. CPC H04W 72/1273

(57) ABSTRACT

Methods, systems, and devices for wireless communications are described. A user equipment (UE) may receive a control message scheduling multi-cell downlink transmissions over a set of carriers, at least two carriers in the set of carriers being associated with different downlink transmissions of the multi-cell downlink transmissions, the control message comprising frequency domain resource allocation information for a set of resource block groups for the at least two carriers in the set of carriers for the multi-cell downlink transmissions. The UE may receive the multi-cell downlink transmissions according to the frequency domain resource allocation information.

### FIELD OF TECHNOLOGY

The following relates to wireless communications, including frequency-domain resource allocation for multi-cell scheduling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support frequency-domain resource allocation (FDRA) for multi-cell scheduling. For example, the described techniques provide for multi-cell scheduling. For example, the described techniques provide various mechanisms for supporting scheduling multiple downlink transmissions to a user equipment (UE) across a set of carriers (e.g., multi-cell downlink transmissions where each carrier is associated with a different cell, each downlink transmission is associated with different carriers, etc.). Some or all of the different cells may be associated with the same network entity and/or may be associated with a different network entity. The network entity may generally identify or otherwise determine to schedule the multi-cell downlink transmissions for the UE. The downlink transmissions may be performed across multiple carriers in a set of carriers. In some examples, some or each carrier in the set of carriers may be associated with a different cell performing a downlink transmission to the UE as part of the multi-cell downlink transmission. Accordingly, the network entity may transmit or otherwise provide a control message (e.g., a downlink control information (DCI) grant) to the UE scheduling the multi-cell downlink transmissions over the set of carriers. In some examples, the control message may carry or otherwise convey FDRA information for the resource block group(s) (RBG)(s) for each carrier. That is, the DCI grant may carry or otherwise convey a FDRA configuration/information for each scheduled carrier/cell. The UE may receive the control message scheduling the multi-cell downlink transmissions and identify or otherwise determine the FDRA information for the set of RBGs for the carriers accordingly. The network entity may transmit or otherwise provide (and the UE may receive or otherwise obtain) the downlink transmissions over each carrier/cell in the set of carriers/cells based, at least to some degree, on the FDRA information.

A method for wireless communications at a UE is described. The method may include receiving a control message scheduling multi-cell downlink transmissions over a set of carriers, at least two carriers in the set of carriers being associated with different downlink transmissions of the multi-cell downlink transmissions, the control message including FDRA information for a set of RBGs for the at least two carriers in the set of carriers for the multi-cell downlink transmissions and receiving the multi-cell downlink transmissions according to the FDRA information.

An apparatus for wireless communications at a UE is described. The apparatus may include a processor, memory coupled with the processor, and instructions stored in the memory. The instructions may be executable by the processor to cause the apparatus to receive a control message scheduling multi-cell downlink transmissions over a set of carriers, at least two carriers in the set of carriers being associated with different downlink transmissions of the multi-cell downlink transmissions, the control message including FDRA information for a set of RBGs for the at least two carriers in the set of carriers for the multi-cell downlink transmissions and receive the multi-cell downlink transmissions according to the FDRA information.

Another apparatus for wireless communications at a UE is described. The apparatus may include means for receiving a control message scheduling multi-cell downlink transmissions over a set of carriers, at least two carriers in the set of carriers being associated with different downlink transmissions of the multi-cell downlink transmissions, the control message including FDRA information for a set of RBGs for the at least two carriers in the set of carriers for the multi-cell downlink transmissions and means for receiving the multi-cell downlink transmissions according to the FDRA information.

A non-transitory computer-readable medium storing code for wireless communications at a UE is described. The code may include instructions executable by a processor to receive a control message scheduling multi-cell downlink transmissions over a set of carriers, at least two carriers in the set of carriers being associated with different downlink transmissions of the multi-cell downlink transmissions, the control message including FDRA information for a set of RBGs for the at least two carriers in the set of carriers for the multi-cell downlink transmissions and receive the multi-cell downlink transmissions according to the FDRA information.

Some examples of the method, apparatuses, and non-transitory computer-readable medium described herein may further include operations, features, means, or instructions for receiving, via the control message, the FDRA information for the at least two carriers according to a configured FDRA type that may be common to the at least two carriers in the set of carriers.

Some examples of the method, apparatuses, and non-transitory computer-readable medium described herein may further include operations, features, means, or instructions for receiving, via the control message, the FDRA information for the at least two carriers according to a FDRA type that may be separately configured for the at least two carriers.

In some examples of the method, apparatuses, and non-transitory computer-readable medium described herein, the set of RBGs may be associated with a RBG size of at least one of 24, 32, 48, 64, or all resource blocks within a bandwidth part (BWP), resource blocks-per-RBG.

Some examples of the method, apparatuses, and non-transitory computer-readable medium described herein may further include operations, features, means, or instructions for receiving, via the control message, the FDRA information for the at least two carriers according to a joint FDRA field of the control message.

Some examples of the method, apparatuses, and non-transitory computer-readable medium described herein may further include operations, features, means, or instructions for identifying a combined bandwidth spanning the set of RBGs for the at least two carriers in the set of carriers and identifying the set of RBGs for the at least two carriers in the set of carriers based on the joint FDRA field of the control message and the combined bandwidth.

In some examples of the method, apparatuses, and non-transitory computer-readable medium described herein, the control message identifies at least one of a starting RBG associated with a first carrier in the set of carriers, a last RBG associated with a last carrier in the set of carriers, or both.

Some examples of the method, apparatuses, and non-transitory computer-readable medium described herein may further include operations, features, means, or instructions for identifying an extended bandwidth exceeding a span of the set of RBGs for the at least two carriers in the set of carriers and identifying the set of RBGs for the at least two carriers in the set of carriers based on the joint FDRA field of the control message and the extended bandwidth.

Some examples of the method, apparatuses, and non-transitory computer-readable medium described herein may further include operations, features, means, or instructions for identifying a number of resource blocks associated with the at least two carriers in the set of carriers and identifying a RBG size for the at least two carriers in the set of carriers based on the number of resource blocks, where the set of RBGs for the at least two carriers in the set of carriers may be based on the RBG size and the number of resource blocks.

Some examples of the method, apparatuses, and non-transitory computer-readable medium described herein may further include operations, features, means, or instructions for receiving an indication of a RBG size for the at least two carriers in the set of carriers.

Some examples of the method, apparatuses, and non-transitory computer-readable medium described herein may further include operations, features, means, or instructions for determining, based on the FDRA information in the control message, a common resource allocation bandwidth to be applied across the at least two carriers in the set of carriers, where the common resource allocation bandwidth defines an extended bandwidth spanning the at least two carriers and one or more gap resource blocks between the at least two carriers.

In some examples of the method, apparatuses, and non-transitory computer-readable medium described herein, the common resource allocation bandwidth includes a fractional resource block for at least one carrier in the set of carriers.

A method for wireless communications at a network entity is described. The method may include transmitting a control message scheduling multi-cell downlink transmissions for a UE over a set of carriers, at least two carriers in the set of carriers being associated with different downlink transmissions of the multi-cell downlink transmissions, the control message indicating FDRA information for a set of RBGs for the at least two carriers in the set of carriers for the multi-cell downlink transmissions and transmitting the multi-cell downlink transmissions according to the FDRA information.

An apparatus for wireless communications at a network entity is described. The apparatus may include a processor, memory coupled with the processor, and instructions stored in the memory. The instructions may be executable by the processor to cause the apparatus to transmit a control message scheduling multi-cell downlink transmissions for a UE over a set of carriers, at least two carriers in the set of carriers being associated with different downlink transmissions of the multi-cell downlink transmissions, the control message indicating FDRA information for a set of RBGs for the at least two carriers in the set of carriers for the multi-cell downlink transmissions and transmit the multi-cell downlink transmissions according to the FDRA information.

Another apparatus for wireless communications at a network entity is described. The apparatus may include means for transmitting a control message scheduling multi-cell downlink transmissions for a UE over a set of carriers, at least two carriers in the set of carriers being associated with different downlink transmissions of the multi-cell downlink transmissions, the control message indicating FDRA information for a set of RBGs for the at least two carriers in the set of carriers for the multi-cell downlink transmissions and means for transmitting the multi-cell downlink transmissions according to the FDRA information.

A non-transitory computer-readable medium storing code for wireless communications at a network entity is described. The code may include instructions executable by a processor to transmit a control message scheduling multi-cell downlink transmissions for a UE over a set of carriers, at least two carriers in the set of carriers being associated with different downlink transmissions of the multi-cell downlink transmissions, the control message indicating FDRA information for a set of RBGs for the at least two carriers in the set of carriers for the multi-cell downlink transmissions and transmit the multi-cell downlink transmissions according to the FDRA information.

Some examples of the method, apparatuses, and non-transitory computer-readable medium described herein may further include operations, features, means, or instructions for transmitting, via the control message, the FDRA information for the at least two carriers according to a configured FDRA type that may be common to the at least two carriers in the set of carriers.

Some examples of the method, apparatuses, and non-transitory computer-readable medium described herein may further include operations, features, means, or instructions for transmitting, via the control message, the FDRA information for the at least two carriers according to a FDRA type that may be separately configured for the at least two carriers in the set of carriers.

In some examples of the method, apparatuses, and non-transitory computer-readable medium described herein, the set of RBGs may be associated with a RBG size of at least one of 24, 32, 48, 64, or all resource blocks within a bandwidth part (BWP), resource blocks-per-RBG, or a combination thereof.

Some examples of the method, apparatuses, and non-transitory computer-readable medium described herein may further include operations, features, means, or instructions for transmitting, via the control message, the FDRA information for the at least two carriers according to a joint FDRA field of the control message.

Some examples of the method, apparatuses, and non-transitory computer-readable medium described herein may further include operations, features, means, or instructions for identifying a combined bandwidth spanning the set of RBGs for the at least two carriers in the set of carriers and identifying the set of RBGs for the at least two carriers in the set of carriers based on the joint FDRA field of the control message and the combined bandwidth.

In some examples of the method, apparatuses, and non-transitory computer-readable medium described herein, the control message identifies at least one of a starting RBG associated with a first carrier in the set of carriers, a last RBG associated with a last carrier in the set of carriers, or both.

Some examples of the method, apparatuses, and non-transitory computer-readable medium described herein may further include operations, features, means, or instructions for identifying an extended bandwidth exceeding a span of the set of RBGs for the at least two carriers in the set of carriers and identifying the set of RBGs for the at least two carriers in the set of carriers based on the joint FDRA field of the control message and the extended bandwidth.

Some examples of the method, apparatuses, and non-transitory computer-readable medium described herein may further include operations, features, means, or instructions for transmitting an indication of a RBG size for the at least two carriers in the set of carriers, where the set of RBGs for the at least two carriers in the set of carriers may be further based on the RBG size for the at least two carriers and a number of resource blocks associated with the at least two carriers in the set of carriers.

Some examples of the method, apparatuses, and non-transitory computer-readable medium described herein may further include operations, features, means, or instructions for identifying a number of resource blocks associated with the at least two carriers in the set of carriers and identifying a RBG size for the at least two carriers in the set of carriers based on the number of resource blocks associated with the at least two carriers, where the set of RBGs for the at least two carriers in the set of carriers may be further based on the RBG size for the at least two carriers in the set of carriers.

Some examples of the method, apparatuses, and non-transitory computer-readable medium described herein may further include operations, features, means, or instructions for determining, based on the FDRA information in the control message, a common resource allocation bandwidth to be applied across the at least two carriers in the set of carriers, where the common resource allocation bandwidth defines an extended bandwidth spanning the at least two carriers and one or more gap resource blocks between the at least two carriers.

In some examples of the method, apparatuses, and non-transitory computer-readable medium described herein, the common resource allocation bandwidth includes a fractional resource block for at least one carrier in the set of carriers.

### BRIEF DESCRIPTION OF THE DRAWINGS

FIG. 1 illustrates an example of a wireless communications system that supports frequency-domain resource allocation (FDRA) for multi-cell scheduling in accordance with one or more aspects of the present disclosure.

FIG. 2 illustrates an example of a wireless communications system that supports FDRA for multi-cell scheduling in accordance with one or more aspects of the present disclosure.

FIGS. 3A and 3B illustrate an example of a FDRA configuration that supports FDRA for multi-cell scheduling in accordance with one or more aspects of the present disclosure.

FIG. 4 illustrates an example of a FDRA configuration that supports FDRA for multi-cell scheduling in accordance with one or more aspects of the present disclosure.

FIG. 5 illustrates an example of a FDRA configuration that supports FDRA for multi-cell scheduling in accordance with one or more aspects of the present disclosure.

FIGS. 6A and 6B illustrate an example of a FDRA configuration that supports FDRA for multi-cell scheduling in accordance with one or more aspects of the present disclosure.

FIGS. 7A and 7B illustrate an example of a FDRA configuration that supports FDRA for multi-cell scheduling in accordance with one or more aspects of the present disclosure.

FIGS. 8A and 8B illustrate an example of a FDRA configuration that supports FDRA for multi-cell scheduling in accordance with one or more aspects of the present disclosure.

FIG. 9 illustrates an example of a FDRA configuration that supports FDRA for multi-cell scheduling in accordance with one or more aspects of the present disclosure.

FIG. 10 illustrates an example of a method that supports FDRA for multi-cell scheduling in accordance with one or more aspects of the present disclosure.

FIGS. 11 and 12 show block diagrams of devices that support FDRA for multi-cell scheduling in accordance with one or more aspects of the present disclosure.

FIG. 13 shows a block diagram of a communications manager that supports FDRA for multi-cell scheduling in accordance with one or more aspects of the present disclosure.

FIG. 14 shows a diagram of a system including a device that supports FDRA for multi-cell scheduling in accordance with one or more aspects of the present disclosure.

FIGS. 15 and 16 show block diagrams of devices that support FDRA for multi-cell scheduling in accordance with one or more aspects of the present disclosure.

FIG. 17 shows a block diagram of a communications manager that supports FDRA for multi-cell scheduling in accordance with one or more aspects of the present disclosure.

FIG. 18 shows a diagram of a system including a device that supports FDRA for multi-cell scheduling in accordance with one or more aspects of the present disclosure.

FIGS. 19 through 23 show flowcharts illustrating methods that support FDRA for multi-cell scheduling in accordance with one or more aspects of the present disclosure.

### DETAILED DESCRIPTION

Wireless communications systems generally include a network entity scheduling uplink and/or downlink transmissions with a user equipment (UE). For example and in the downlink scenario, this may include a network entity transmitting control messages (e.g., downlink control information (DCI) grant(s) to the UE scheduling the downlink transmission. The control message generally identifies various parameters for the downlink transmission as well as identifying or otherwise indicating which resources are to be used for the downlink transmission. For example, the DCI grant may carry a time domain resource allocation (TDRA) indication, a frequency domain resource allocation (FDRA) indication, a spatial domain resource allocation (SDRA), and the like. More particularly, the FDRA indication may generally identify the frequency resources by indicating a physical resource block (PRB) index assigned per downlink bandwidth part (BWP), with the BWP identifying the bandwidth in the frequency domain for the downlink transmission. However, advanced wireless networks may support scheduling multiple downlink transmissions to the UE across multiple carriers (e.g., from different cells). Conventional networks do not provide a mechanism for a network entity to schedule multiple downlink transmissions across different carriers (e.g., cells) for the UE.

Accordingly, aspects of the described techniques relate to improved methods, systems, devices, and apparatuses that support FDRA for multi-cell scheduling. For example, the described techniques provide various mechanisms for supporting scheduling multiple downlink transmissions to a UE across a set of carriers (e.g., multi-cell downlink transmissions where each carrier is associated with a different cell, a multi-cell downlink transmission across multiple carriers, etc.). Some or all of the different cells may be associated with the same network entity and/or may be associated with a different network entity. The network entity may generally identify or otherwise determine to schedule the multi-cell downlink transmissions for the UE. The downlink transmissions may be performed across multiple carriers in a set of carriers. In some examples, some or each carrier in the set of carriers may be associated with a different cell performing a downlink transmission to the UE as part of the multi-cell downlink transmission. Accordingly, the network entity may transmit or otherwise provide a control message (e.g., a DCI grant) to the UE scheduling the multi-cell downlink transmissions over the set of carriers. In some examples, the control message may carry or otherwise convey FDRA information for the resource block group(s) (RBG)(s) for each carrier. That is, the DCI grant may carry or otherwise convey a FDRA configuration/information for each scheduled carrier/cell. The UE may receive the control message scheduling the multi-cell downlink transmissions and identify or otherwise determine the FDRA information for the set of RBGs for the carriers accordingly. The network entity may transmit or otherwise provide (and the UE may receive or otherwise obtain) the downlink transmissions over each carrier/cell in the set of carriers/cells based, at least to some degree, on the FDRA information.

Aspects of the disclosure are initially described in the context of wireless communications systems. Aspects of the disclosure are further illustrated by and described with reference to apparatus diagrams, system diagrams, and flowcharts that relate to FDRA for multi-cell scheduling.

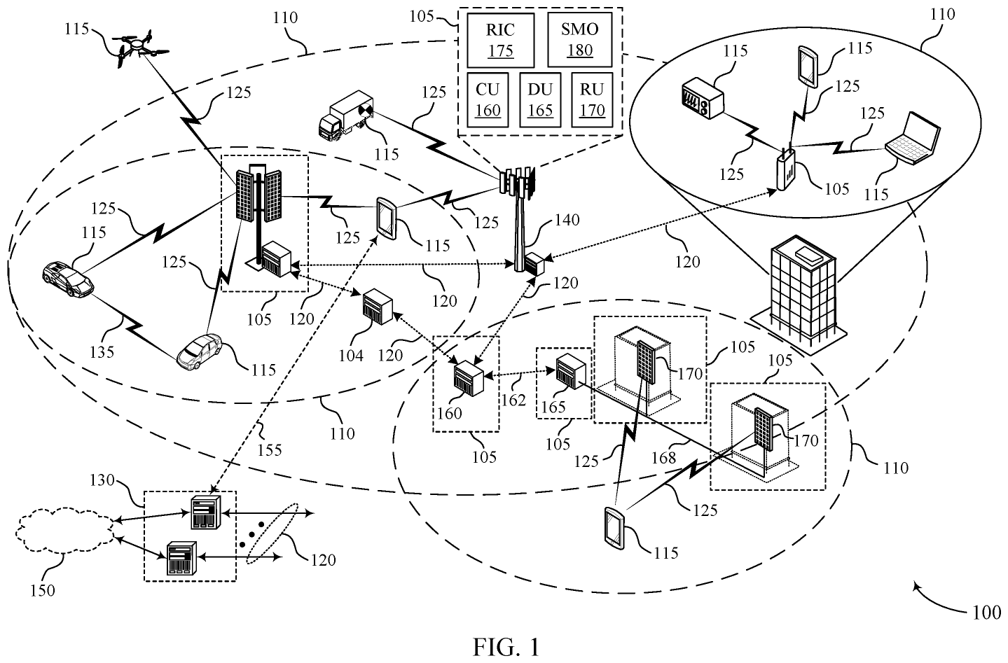

FIG. 1 illustrates an example of a wireless communications system 100 that supports FDRA for multi-cell scheduling in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support FDRA for multi-cell scheduling as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

A UE 115 may receive a control message scheduling multi-cell downlink transmissions over a set of carriers, at least two carriers in the set of carriers being associated with different downlink transmissions of the multi-cell downlink transmissions, the control message comprising FDRA information for a set of RBGs for the at least two carriers in the set of carriers for the multi-cell downlink transmissions. The UE 115 may receive the multi-cell downlink transmissions according to the FDRA information.

A network entity 105 may transmit a control message scheduling multi-cell downlink transmissions for a UE 115 over a set of carriers, at least two carriers in the set of carriers being associated with different downlink transmissions of the multi-cell downlink transmissions, the control message indicating FDRA information for a set of RBGs for the at least two carriers in the set of carriers for the multi-cell downlink transmissions. The network entity 105 may transmit the multi-cell downlink transmissions according to the FDRA information.

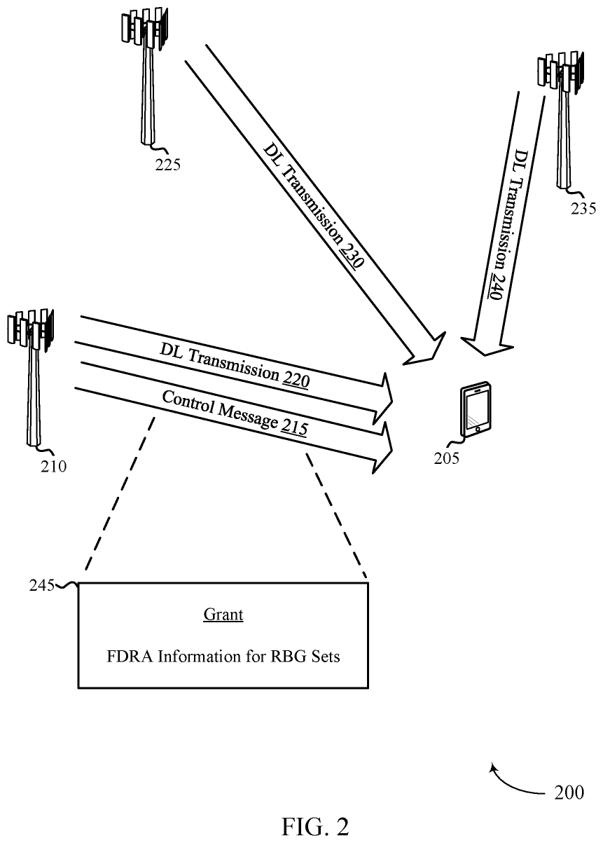

FIG. 2 illustrates an example of a wireless communications system 200 that supports FDRA for multi-cell scheduling in accordance with one or more aspects of the present disclosure. Wireless communications system 200 may implement aspects of wireless communications system 100. Wireless communications system 200 may include UE 205, network entity 210, network entity 225, and/or network entity 235, which may be examples of the corresponding devices described herein. In some examples, network entity 210, network entity 225, and network entity 235 may be examples or representations of a cell and/or carrier scheduled to perform multi-cell downlink transmissions to UE 205, with network entity 210 being the scheduling entity in this example.

Wireless communications system 200 may generally include a network entity (e.g., network entity 210 in this non-limiting example) scheduling uplink and/or downlink transmissions with UE 205. For example and in the downlink scenario, this may include network entity 210 transmitting control messages (e.g., control message 215, which may include a DCI grant 245) to UE 205 scheduling the downlink transmission. The control message generally identifies various parameters for the downlink transmission as well as identifying or otherwise indicating which resources are to be used for the downlink transmission. For example, the DCI grant 245 may carry a TDRA indication, a FDRA indication, a SDRA, and the like.

More particularly, the FDRA indication may generally identify the frequency resources by indicating a PRB index assigned per BWP, with the BWP identifying the bandwidth in the frequency domain for the downlink transmission. Two types of FDRA indications may be provided. One type includes a FDRA type 0 where the FDRA field indicated in the scheduling DCI is a bitmap field indicating whether each RBG is scheduled, or not. For example, each bit in the bitmap may correspond to a specific RBG within the BWP and be set to a value (e.g., 1 or 0) to indicate whether that RBG (e.g., the RB(s) within the RBG) is scheduled. The RBG size may depend on the bandwidth of the BWP (e.g., the number of RBs within the BWP and the RBG size may determine the number of RBGs). The edge RBG(s) of the BWP may have fewer RBs than the other RBGs within the BWP.

Another type includes a FDRA type 1 where the FDRA field indicated in the scheduling DCI is a resource indication vector (RIV) field. That is, each codepoint of the RIV field may be associated with a starting RB and the number of RBs consecutively scheduled from the starting RB. In some options, the FDRA type 1 may optionally support RBG size 2, 4, 8, 16 RBs granularity. Generally, the network may dynamically switch between the FDRA type 0 and FDRA type 1, or vice versa. Generally, the scheduling DCI may include one bit indicating which FDRA type to use for interpreting the indicated FDRA.

Regarding the number of bits used in the scheduling DCI to indicate the FDRA, each FDRA type is associated with different considerations. For the FDRA type 0 example, the RBG size is 2′, where n=1, 2, 3, or 4, and the RBG size is determined such that the number of FDRA bits is less than/equal to (≤) 18 bits. That is, conventional techniques may select the RBG size for the communications such that, when using the FDRA type 0 FDRA indication, no more than 18 bits are used in the scheduling DCI. Plus and for both FDRA type 0 and type 1, the dynamic indication of the selection of the FDRA type (e.g., the resource allocation (RA)), the scheduling DCI includes one bit (e.g., one additional bit) that indicates whether the FDRA indication for this particular transmission is interpreted as type 0 or type 1. This means that the maximum number of FDRA bits in the scheduling DCI equal to the maximum number of FDRA bits (e.g., the RIV field or the starting RB/length bitmap) plus one more bit for the FDRA type indication (e.g., number of FDRA bits=max {FDRA for type 0, FDRA for type 1}.

However, advanced wireless networks (e.g., wireless communications system 200) may support scheduling multiple downlink transmissions to UE 205 across multiple carriers (e.g., from different cells). Conventional networks do not provide a mechanism for a network entity (e.g., such as network entity 210) to schedule multiple downlink transmissions across different carriers (e.g., cells) for UE 205 by a single DCI (or control message, or PDCCH, etc.). For example, in conventional networks N DCI formats may be used to schedule N downlink transmissions.

Accordingly, aspects of wireless communications system 200 may support UE 205 being scheduled for a multi-cell downlink transmission over a set of carriers. In some examples, the multi-cell downlink transmissions over the set of carriers may refer to downlink transmissions from multiple cells, where some or all of the cells are performing a downlink transmission to UE 205. For example, some or all of the cells may be associated with different carriers. In some examples, the multi-cell downlink transmissions over the set of carriers may refer to downlink transmissions from a single cell, where the cell uses different carriers to perform some or all of the multiple downlink transmissions to UE 205. For example, the downlink transmissions may be performed by different RHs, TRPs, etc., associated with or otherwise managed by the cell. Accordingly and within this context, the terms “cell” or “cells” and “carrier” or “carriers” may be used interchangeably.

In some aspects, this may include UE 205 receiving a control message 215. In some examples, UE 205 may receive the control message 215 from a network entity, such as network entity 210. For example, network entity 210 may be associated with one, some or all of the cells performing the downlink transmissions to UE 205. In the non-limiting example illustrated in FIG. 2, the multi-cell downlink transmissions may be performed by network entity 210, network entity 225, and network entity 235. For example, network entity 210 may perform a downlink transmission 220 to UE 205, network entity 225 may perform a downlink transmission 230 to UE 205, and network entity 235 may perform a downlink transmission 240 to UE 205 as part of the multi-cell downlink transmissions. Of course it is to be understood that the multi-cell may include a different number of downlink transmissions being performed.

In some aspects, the control message 215 may schedule the multi-cell downlink transmissions for UE 205 over the set of carriers. As discussed above, in some examples some or all (e.g., at least two or more than two, such as all) of the carriers (e.g., carriers and/or cells) may be associated with a different downlink transmission. For example, the control message 215 may carry or otherwise convey a FDRA information for the set of RBGs for some or all (e.g., the at least two) carriers. That is, each downlink transmission may generally span a given bandwidth in the frequency domain. A RB is generally defined as 12 subcarriers in the frequency domain during one OFDM symbol in the time domain. A RBG may generally identify a set of RBs (e.g., one or more RBs per RBG). The set of RBGs may refer to the RBG(s) (e.g., one or more RBGs per downlink transmission) allocated to a single downlink transmission in the frequency domain. In some examples, the control message 215 may carry or otherwise convey (e.g., in or separate from the FDRA information) an indication of at least aspects of the RBG set information for each downlink transmission.

That is, the control message 215 may carry FDRA information for some or all (e.g., each) carrier/cell being scheduled for the multi-cell downlink transmissions to UE 205. In some examples, the control message 215 may be a scheduling DCI (e.g., dynamic) scheduling the multi-cell downlink transmissions). In some examples, the control message 215 may be an activating DCI (e.g., activating one or more semi-persistent scheduling (SPS) configuration(s) previously configured for UE 205) for the multi-cell downlink transmissions.

In some examples, the FDRA information carried or otherwise conveyed in the control message 215 may include a separate FDRA field being indicated for some or all (e.g., two or more, each, etc.) carrier/cell scheduled by the control message 215. For example, control message 215 may include a first FDRA field/indication for downlink transmission 220 from network entity 210, a second FDRA field/indication for downlink transmission 230 from network entity 225, and a third FDRA field/indication for downlink transmission 240 from network entity 235.

In some examples, the FDRA information carried or otherwise conveyed in the control message 215 may be one (e.g., joint) FDRA field/indication for some or all (e.g., two or more, each, etc.) of the downlink transmissions being scheduled. For example, the single/joint FDRA field/indication may be based on a mechanism understood by UE 205 and the scheduling network entity such that UE 205 may determine the set of RBGs for each downlink transmission based on the single/joint FDRA field/indication. For example, a combined bandwidth spanning some or all of the downlink transmissions may be indicated in the single/joint FDRA field/indication carried in control message 215. The combined bandwidth may cover (e.g., span, overlap, etc.) the set of RBGs scheduled for each downlink transmission.

Accordingly, UE 205 may receive the multi-cell downlink transmissions according to the FDRA information carried or otherwise conveyed in control message 215. Again, the non-limiting example illustrated in FIG. 2 includes UE 205 receiving downlink transmission 220 from network entity 210, receiving downlink transmission 230 from network entity 225, and receiving downlink transmission 240 from network entity 235.

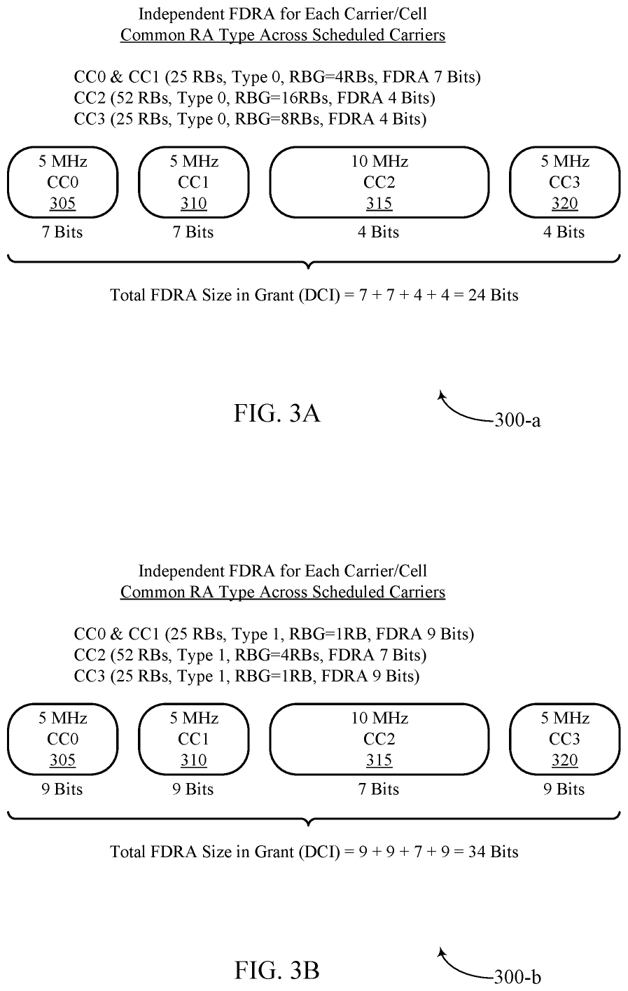

FIGS. 3A and 3B illustrate an example of a FDRA configuration 300 that supports FDRA for multi-cell scheduling in accordance with one or more aspects of the present disclosure. FDRA configuration 300 may implement aspects of wireless communications systems 100 and/or 200. Aspects of FDRA configuration 300 may be implemented at or implemented by a UE and/or network entity, which may be examples of the corresponding devices described herein.

Aspects of the techniques described herein provide a mechanism to schedule a UE for multi-cell downlink transmissions across a set of carriers/cells. In some examples, some or all (e.g., two or more) of the carriers/cells scheduled for the multi-cell downlink transmissions may be associated with a different downlink transmission. The UE may receive a control message scheduling the multi-cell downlink transmissions (e.g., a DCI). The control message may carry or otherwise convey FDRA information for the set of RBGs for some or all (e.g., two or more) of the carriers/cells scheduled for the downlink transmissions. Accordingly, the UE may receive the multi-cell downlink transmissions based on the control message (e.g., according to the FDRA information).

As discussed above, in some examples the control message may carry or otherwise convey independent FDRA fields/indications for some or all (e.g., two or more) scheduled carriers/cells. That is, for each (e.g., some or all) carrier/cell being scheduled for a downlink transmission to the UE, the control message may carry or otherwise provide a separate FDRA field/indication. The FDRA configuration indicated for some or all (e.g., two or more) of the cells/carriers being scheduled may indicate various information, such as the resource allocation (RA) type (e.g., FDRA type 0 or FDRA type 1), the RBG size, etc.

In some examples, the control message may carry a common RA type across some or all of the scheduled carriers/cells. That is, in some examples where separate FDRA fields/indications are provide for some or all (e.g., two or more) of the scheduled carriers/cells, each FDRA field/indication may use the same FDRA type (e.g., type 0 or type 1).

More particularly and with reference to FDRA configuration 300-a of FIG. 3A, multi-cell downlink transmissions may be scheduled across four carriers/cells. For example, a first downlink transmission 305 may be scheduled across CC0 that spans 5 MHz in the frequency domain, a second downlink transmission 310 may be scheduled across CC1 that spans 5 MHz, a third downlink transmission 315 may be scheduled across CC2 that spans 10 MHz, and a fourth downlink transmission 320 may be scheduled across CC3 that spans 5 MHz. The FDRA fields/indications for the first downlink transmission 305 and the second downlink transmission 310 may indicate that each downlink transmission includes 25 RBs, with four RBs being included in each RBG (e.g., each RBG in the set of RBGs includes four RBs in the frequency domain). The FDRA fields/indications may also indicate that the FDRA field/indication is a FDRA type 0 for both the first downlink transmission 305 and the second downlink transmission 310. Each FDRA field/indication for the first downlink transmission 305 and the second downlink transmission 310 may use 7 bits to indicate this information.

Similarly, the FDRA field/indication for the third downlink transmission 315 may indicate that 52 RBs are scheduled, with 16 RBs being included in each RBG. The FDRA field/indication for the third downlink transmission 315 may indicate that the FDRA field/indication is a FDRA type 0. The FDRA field/indication for the third downlink transmission 315 may use four bits to indicate this information. Lastly, the FDRA field/indication for the fourth downlink transmission 320 may indicate that 25 RBs are scheduled, with eight RBs being included in each RBG. The FDRA field/indication for the fourth downlink transmission 320 may indicate that the FDRA field/indication is a FDRA type 0. The FDRA field/indication for the fourth downlink transmission 320 may use four bits to indicate this information. Accordingly, total size of the FDRA fields/indications carried in the control message may be 24 bits to schedule the multi-cell downlink transmissions to the UE.

With reference to FDRA configuration 300-b of FIG. 3B, multi-cell downlink transmissions may be scheduled across four carriers/cells. Again, a first downlink transmission 305 may be scheduled across CC0 that spans 5 MHz in the frequency domain, a second downlink transmission 310 may be scheduled across CC1 that spans 5 MHz, a third downlink transmission 315 may be scheduled across CC2 that spans 10 MHz, and a fourth downlink transmission 320 may be scheduled across CC3 that spans 5 MHz. The FDRA fields/indications for the first downlink transmission 305 and the second downlink transmission 310 may indicate that each downlink transmission includes 25 RBs, with one RB being included in each RBG. The FDRA fields/indications may also indicate that the FDRA field/indication is a FDRA type 1 for both the first downlink transmission 305 and the second downlink transmission 310. Each FDRA field/indication for the first downlink transmission 305 and the second downlink transmission 310 may use nine bits to indicate this information.

Similarly, the FDRA field/indication for the third downlink transmission 315 may indicate that 52 RBs are scheduled, with four RBs being included in each RBG. The FDRA field/indication for the third downlink transmission 315 may indicate that the FDRA field/indication is a FDRA type 1. The FDRA field/indication for the third downlink transmission 315 may use seven bits to indicate this information. Lastly, the FDRA field/indication for the fourth downlink transmission 320 may indicate that 25 RBs are scheduled, with one RB being included in each RBG. The FDRA field/indication for the fourth downlink transmission 320 may indicate that the FDRA field/indication is a FDRA type 1. The FDRA field/indication for the fourth downlink transmission 320 may use nine bits to indicate this information. Accordingly, total size of the FDRA fields/indications carried in the control message may be 30 bits to schedule the multi-cell downlink transmissions to the UE.

Accordingly, in both FDRA configuration 300-a and FDRA configuration 300-b, the UE may receive or otherwise obtain the FDRA information for some or all of the carriers/cells (e.g., two or more) using the FDRA type that is common to the carrier/cells scheduled for the multi-cell downlink transmissions.

In some examples, it is to be understood that larger RBG size(s) may be used for the FDRA fields/indications (e.g., for FDRA type 0 and/or FDRA type 1). For example, RBG sizes of 24 RBs/RBG, 32, RBs/RBG, 64 RBs/RBG, etc., may be signaled in the FDRA fields/indications. In some examples, the RBG size indicated in the FDRA fields/indications may be for all of the RBs in the BWP (e.g., for all RBs in the first downlink transmission 305, the second downlink transmission 310, the third downlink transmission 315, and the fourth downlink transmission 320).

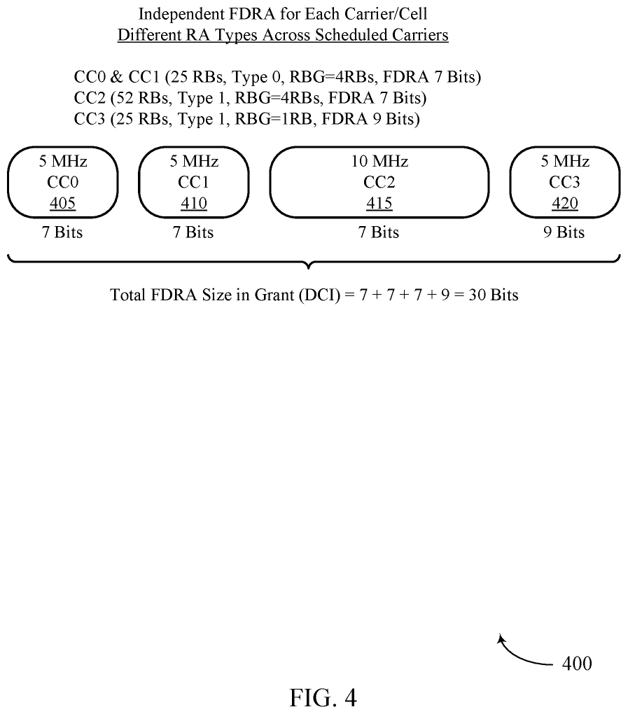

FIG. 4 illustrates an example of a FDRA configuration 400 that supports FDRA for multi-cell scheduling in accordance with one or more aspects of the present disclosure. FDRA configuration 400 may implement aspects of wireless communications systems 100 and/or 200. Aspects of FDRA configuration 400 may be implemented at or implemented by a UE and/or network entity, which may be examples of the corresponding devices described herein.

Aspects of the techniques described herein provide a mechanism to schedule a UE for multi-cell downlink transmissions across a set of carriers/cells. In some examples, some or all (e.g., two or more) of the carriers/cells scheduled for the multi-cell downlink transmissions may be associated with a different downlink transmission. The UE may receive a control message scheduling the multi-cell downlink transmissions (e.g., a DCI). The control message may carry or otherwise convey FDRA information for the set of RBGs for some or all (e.g., two or more) of the carriers/cells scheduled for the downlink transmissions. Accordingly, the UE may receive the multi-cell downlink transmissions based on the control message (e.g., according to the FDRA information).

As discussed above, in some examples the control message may carry or otherwise convey independent FDRA fields/indications for some or all (e.g., two or more) scheduled carriers/cells. That is, for each (e.g., some or all) carrier/cell being scheduled for a downlink transmission to the UE, the control message may carry or otherwise provide a separate FDRA field/indication. The FDRA configuration indicated for some or all (e.g., two or more) of the cells/carriers being scheduled may indicate various information, such as the RA type (e.g., FDRA type 0 or FDRA type 1), the RBG size, etc.

In some examples, the control message may carry separately configured RA types across some or all of the scheduled carriers/cells. That is, in some examples where separate FDRA fields/indications are provide for some or all (e.g., two or more) of the scheduled carriers/cells, one, some, or all (e.g., two or more) FDRA field/indication may use different FDRA types (e.g., some FDRA field(s)/indications may use a FDRA type 0 while other FDRA field(s)/indication(s) may use a FDRA type 1).

For example, multi-cell downlink transmissions may be scheduled across four carriers/cells. For example, a first downlink transmission 405 may be scheduled across CC0 that spans 5 MHz in the frequency domain, a second downlink transmission 410 may be scheduled across CC1 that spans 5 MHz, a third downlink transmission 415 may be scheduled across CC2 that spans 10 MHz, and a fourth downlink transmission 420 may be scheduled across CC3 that spans 5 MHz. The FDRA fields/indications for the first downlink transmission 405 and the second downlink transmission 410 may indicate that each downlink transmission includes 25 RBs, with four RBs being included in each RBG. The FDRA fields/indications may also indicate that the FDRA field/indication is a FDRA type 0 for both the first downlink transmission 405 and the second downlink transmission 410. Each FDRA field/indication for the first downlink transmission 405 and the second downlink transmission 410 may use seven bits to indicate this information.

The FDRA field/indication for the third downlink transmission 415 may indicate that 52 RBs are scheduled, with four RBs being included in each RBG. The FDRA field/indication for the third downlink transmission 415 may indicate that the FDRA field/indication is a FDRA type 1 (e.g., a different FDRA type from the FDRA type used for the other downlink transmissions). The FDRA field/indication for the third downlink transmission 415 may use seven bits to indicate this information. Lastly, the FDRA field/indication for the fourth downlink transmission 420 may indicate that 25 RBs are scheduled, with one RB being included in each RBG. The FDRA field/indication for the fourth downlink transmission 420 may indicate that the FDRA field/indication is a FDRA type 1. The FDRA field/indication for the fourth downlink transmission 420 may use nine bits to indicate this information. Accordingly, total size of the FDRA fields/indications carried in the control message may be 30 bits to schedule the multi-cell downlink transmissions to the UE.

Accordingly, FDRA configuration 400 illustrates an example where the UE may receive or otherwise obtain the FDRA information for some or all of the carriers/cells (e.g., two or more) using FDRA types that are different to the carrier/cells scheduled for the multi-cell downlink transmissions.

In some examples, it is to be understood that larger RBG size(s) may be used for the FDRA fields/indications (e.g., for FDRA type 0 and/or FDRA type 1). For example, RBG sizes of 24 RBs/RBG, 32, RBs/RBG, 64 RBs/RBG, etc., may be signaled in the FDRA fields/indications. In some examples, the RBG size indicated in the FDRA fields/indications may be for all of the RBs in the BWP (e.g., for all RBs in the first downlink transmission 405, the second downlink transmission 410, the third downlink transmission 415, and the fourth downlink transmission 420).

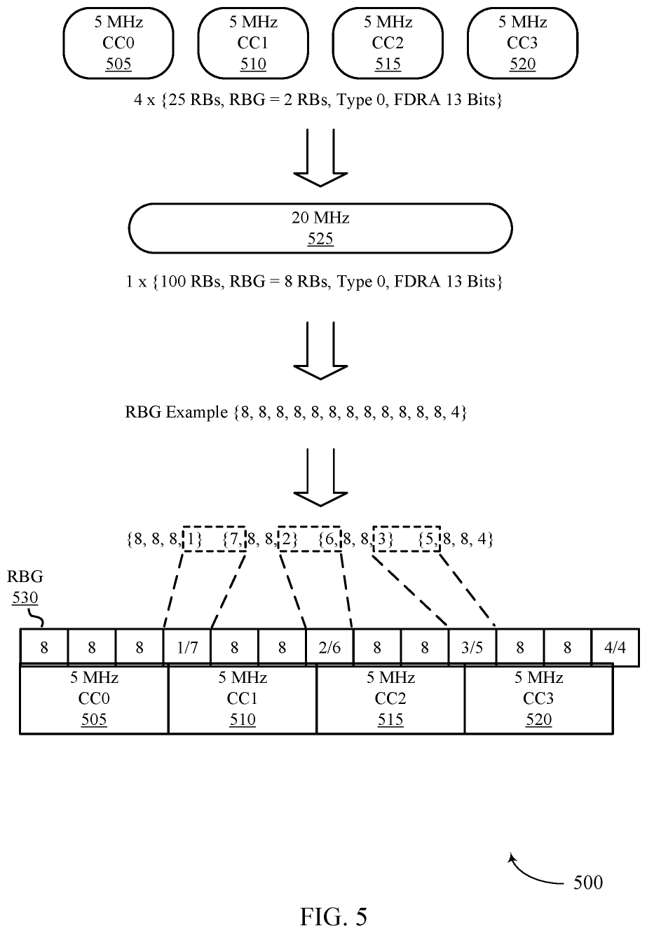

FIG. 5 illustrates an example of a FDRA configuration 500 that supports FDRA for multi-cell scheduling in accordance with one or more aspects of the present disclosure. FDRA configuration 500 may implement aspects of wireless communications systems 100 and/or 200. Aspects of FDRA configuration 500 may be implemented at or implemented by a UE and/or network entity, which may be examples of the corresponding devices described herein.

Aspects of the techniques described herein provide a mechanism to schedule a UE for multi-cell downlink transmissions across a set of carriers/cells. In some examples, some or all (e.g., two or more) of the carriers/cells scheduled for the multi-cell downlink transmissions may be associated with a different downlink transmission. The UE may receive a control message scheduling the multi-cell downlink transmissions (e.g., a DCI). The control message may carry or otherwise convey FDRA information for the set of RBGs for some or all (e.g., two or more) of the carriers/cells scheduled for the downlink transmissions. Accordingly, the UE may receive the multi-cell downlink transmissions based on the control message (e.g., according to the FDRA information).

As discussed above, in some examples the control message may carry or otherwise convey a single FDRA field/indication for some or all (e.g., two or more) scheduled carriers/cells. That is, for each (e.g., some or all) carrier/cell being scheduled for a downlink transmission to the UE, the control message may carry or otherwise provide a single or joint FDRA field/indication. The joint FDRA configuration indicated for the cells/carriers being scheduled may indicate various information, such as the RA type (e.g., FDRA type 0 or FDRA type 1), the RBG size, etc.

In some aspects, this may include a bandwidth for the resource allocation (“BW for RA”) being configured. For example, the RBs (e.g., physical RBs) for multiple carriers/cells may be considered as contiguous RBs and the contiguous RBs may be treated as the BW for RA. In some examples, the multiple carriers/cells may not necessarily be mapped to the same RB grid physically (e.g., different carriers may have different point A references).

In the non-limiting example illustrated in FIG. 5, the multi-cell downlink transmissions may be scheduled across four carriers/cells. For example, a first downlink transmission 505 may be scheduled across CC0 that spans 5 MHz in the frequency domain, a second downlink transmission 510 may be scheduled across CC1 that spans 5 MHz, a third downlink transmission 515 may be scheduled across CC2 that spans 5 MHz, and a fourth downlink transmission 520 may be scheduled across CC3 that spans 5 MHz. Conventionally, the FDRA fields/indications for each downlink transmission would indicate that each downlink transmission includes 25 RBs, with two RBs being included in each RBG. The FDRA fields/indications may also indicate that the FDRA field/indication is a FDRA type 0 for all of the downlink transmissions. Each FDRA field/indication for any given downlink transmission would use 13 bits to indicate this information, with the total number of bits used in the control message being the multiple of the number of scheduled carriers/cells (e.g., 4×13=52 being used in the control message).

However, defining the BW for RA according to the techniques describe herein include a joint FDRA field/indication being provided in the control message. The joint FDRA field/indication may indicate that downlink transmission 525 defined based on the BW for RA includes 100 RBs, with eight RBs being included in each RBG. The joint FDRA field/indication may also indicate that the FDRA field/indication is a FDRA type 0. Using this approach, the joint FDRA field/indication scheduling the downlink transmission would use 13 bits in total to indicate this information.

Thus, in this example where there are four carriers/cells scheduled with each having 25 RBs, the total of 25×4=100 RBs are treated as the BW for RA. Then, for the BW for RA, the joint FDRA field/indication may indicate the FDRA information for the multi-cell downlink transmissions. Accordingly, the UE may identify the combined bandwidth (e.g., the BW for RA) spanning the set of RBGs for some or all (e.g., two or more) of the carriers/cells and then identify the set of RBGs based on the joint FDRA field/indication.

For example and as is illustrated in FIG. 5, the set of RBGs 530 indicated in the joint FDRA field/indication may include a total of 100 RBs divided into 8 RBs/RBG, which results in a set of RBGs 530 consisting of {8 RBs, 8 RBs, 8 RBs, 8 RBs, 8 RBs, 8 RBs, 8 RBs, 8 RBs, 8 RBs, 8 RBs, 8 RBs, 8 RBs, and 4 RBs}.

In some examples and for the FDRA type 0 scenario, the first RBG and/or the last RBG of the BW for RA may have less than the configured number of RBs per RBG (e.g., the last RBG in this non-limiting example includes four RBs, rather than the configured eight RBs per RBG). In some aspects, the first RBG of the BW for RA may be determined by the first RB of the first carrier/cell (e.g., the carrier/cell having the lowest CC/cell index or the carrier/cell configured as PCell or PSCell) and the last RBG of the BW for RA may be the last RBG of the last carrier (e.g., the carrier/cell having the largest or highest CC/cell index).

As illustrated in FIG. 5, each carrier/cell includes 25 RBs even though the RBG size is configured as eight RBs per RBG for the set of RBGs 530. As 25 is not equally divisible by eight, this may result in some RBGs including RBs for different carriers/cells. For example, the 25 RBs corresponding to the first downlink transmission 505 may include three RBGs having eight RBs, with the fourth RBG having one RB. The remaining seven RBs of the fourth RBG of the first downlink transmission 505 may be the first seven RBs of the first RBG of the second downlink transmission 510. For the second downlink transmission 510, the RBG grid may include those seven RBs and two RBGs including eight RBs each. The last RBG of the second downlink transmission 510 may include two RBs in the last RBG, with the remaining six RBs being allocated to the first RBG of the third downlink transmission 515. The third downlink transmission 515 may include two addition RBGs having eight RBs each. The last RBG of the third downlink transmission may use three RBs of the RBG, with the remaining five RBs of the RBG being allocated to the first RBG of the fourth downlink transmission 520. Thus, the first RBG of the fourth downlink transmission includes five RBs, with the next two RBGs each including eight RBs. The final RBG of the fourth downlink transmission 520 may include four RBs, with the remaining four RBs being unused for the downlink transmissions.

Accordingly, in this example the FDRA information may include the joint FDRA field/indication that signals or otherwise identifies the starting RBG associated with the first carrier (e.g., CC0) and/or the last RBG associated with the last carrier (e.g., CC3). The approach illustrated in FIG. 5 includes the 25 RBs across the four carriers/cells being lumped together as a contiguous block of 100 RBs that are divided into eight RBs per RBG. This ordering of the carriers contiguously may result in some RBGs containing RBs of multiple carriers (e.g., 1/7, 2/6, and 3/5). In some aspects, utilizing such techniques may schedule RBs according to the RBG configuration enforcing multi-carrier scheduling.

Accordingly, the UE may identify or otherwise determine the number of RBs associated with some or all (e.g., two or more) of the carriers and then identify or otherwise determine the RBG size based on the number of RBs. This may include the RBG size being determined based on the number of RBs in the BW for RA (e.g., extending existing FDRA tables for the RBG sizes given the number of RBs per bandwidth). This may include the RBG size being determined based on the UE receiving an indication of the RBG size (e.g., by RRC signaling indicating RBG sizes of {2, 4, 8, 16, 24, 32, 48, 64, etc.} RBs per RBG).

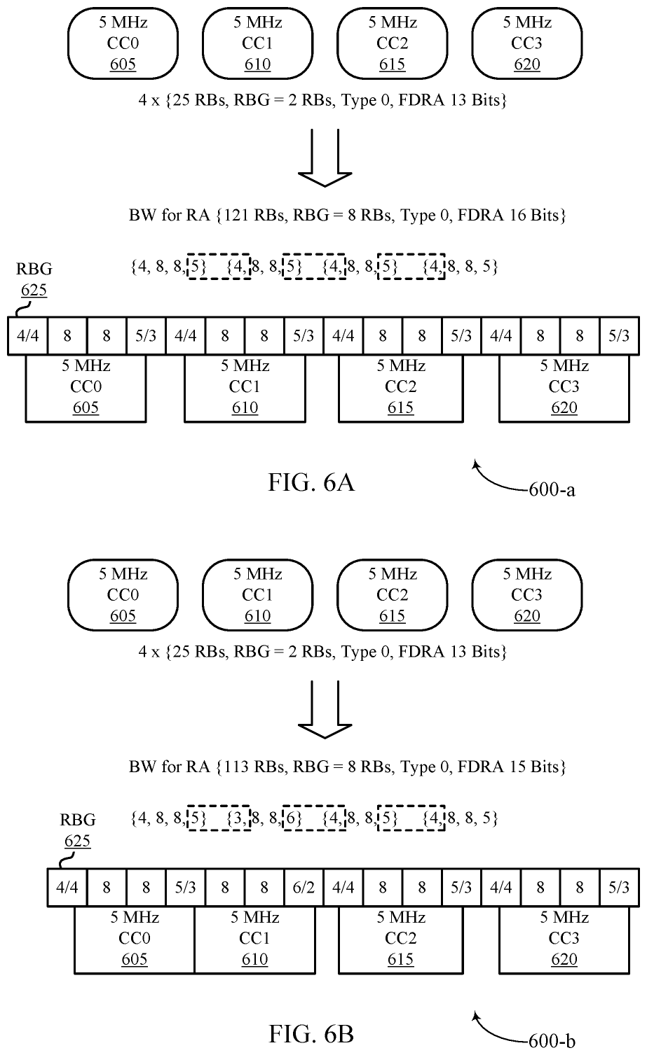

FIGS. 6A and 6B illustrate an example of a FDRA configuration 600 that supports FDRA for multi-cell scheduling in accordance with one or more aspects of the present disclosure. FDRA configuration 600 may implement aspects of wireless communications systems 100 and/or 200. Aspects of FDRA configuration 600 may be implemented at or implemented by a UE and/or network entity, which may be examples of the corresponding devices described herein.

Aspects of the techniques described herein provide a mechanism to schedule a UE for multi-cell downlink transmissions across a set of carriers/cells. In some examples, some or all (e.g., two or more) of the carriers/cells scheduled for the multi-cell downlink transmissions may be associated with a different downlink transmission. The UE may receive a control message scheduling the multi-cell downlink transmissions (e.g., a DCI). The control message may carry or otherwise convey FDRA information for the set of RBGs for some or all (e.g., two or more) of the carriers/cells scheduled for the downlink transmissions. Accordingly, the UE may receive the multi-cell downlink transmissions based on the control message (e.g., according to the FDRA information).

As discussed above, in some examples the control message may carry or otherwise convey a single FDRA field/indication for some or all (e.g., two or more) scheduled carriers/cells. That is, for each (e.g., some or all) carrier/cell being scheduled for a downlink transmission to the UE, the control message may carry or otherwise provide a single or joint FDRA field/indication. The joint FDRA configuration indicated for the cells/carriers being scheduled may indicate various information, such as the RA type (e.g., FDRA type 0 or FDRA type 1), the RBG size, etc.

In some aspects, this may include the BW for RA being configured. For example, the RBs (e.g., physical RBs) for multiple carriers/cells may be considered as non-contiguous RBs and the non-contiguous RBs may be treated as the BW for RA. In some examples, the multiple carriers/cells may not necessarily be mapped to the same RB grid physically (e.g., different carriers may have different point A references).

As discussed above, the approach illustrated in FIG. 5 includes the 25 RBs across the four carriers/cells being lumped together as a contiguous block of 100 RBs that are divided into eight RBs per RBG. This ordering of the carriers contiguously may result in some RBGs containing RBs of multiple carriers (e.g., 1/7, 2/6, and 3/5). In some aspects, utilizing such techniques may schedule RBs according to the RBG configuration enforcing multi-carrier scheduling.

However, the non-limiting examples illustrated in FIG. 6 use a BW for RA that is configured to have a wider (e.g., extended) bandwidth than is necessary. In this example, the RBs of each carrier/cell may be mapped onto any non-overlapping portion of the BW for RA.

Turning first to FDRA configuration 600-a of FIG. 6A, the multi-cell downlink transmissions may be scheduled across four carriers/cells. For example, a first downlink transmission 605 may be scheduled across CC0 that spans 5 MHz in the frequency domain, a second downlink transmission 610 may be scheduled across CC1 that spans 5 MHz, a third downlink transmission 615 may be scheduled across CC2 that spans 5 MHz, and a fourth downlink transmission 620 may be scheduled across CC3 that spans 5 MHz. Conventionally, the FDRA fields/indications for each downlink transmission would indicate that each downlink transmission includes 25 RBs, with two RBs being included in each RBG 625. The FDRA fields/indications may also indicate that the FDRA field/indication is a FDRA type 0 for all of the downlink transmissions. Each FDRA field/indication for any given downlink transmission would use 13 bits to indicate this information, with the total number of bits used in the control message being the multiple of the number of scheduled carriers/cells (e.g., 4×13=52 bits being used in the control message).

However, defining the BW for RA according to the techniques describe herein include a joint FDRA field/indication being provided in the control message. The joint FDRA field/indication may indicate that downlink transmission may be defined based on the BW for RA that includes 121 RBs, with eight RBs being included in each RBG 625. The joint FDRA field/indication may also indicate that the FDRA field/indication is a FDRA type 0. Using this approach, the joint FDRA field/indication scheduling the downlink transmission would use 16 bits in total to indicate this information.

Thus, in this example where there are four carriers/cells scheduled with each having 25 RBs, the total of 25×4=100 RBs plus 21 additional RBs are treated as the BW for RA (e.g., the extended bandwidth). Then, for the BW for RA, the joint FDRA field/indication may indicate the FDRA information for the multi-cell downlink transmissions. Accordingly, the UE may identify the extended bandwidth (e.g., the BW for RA) spanning the set of RBGs for some or all (e.g., two or more) of the carriers/cells and then identify the set of RBGs based on the joint FDRA field/indication.

For example and as is illustrated in FIG. 6A, the set of RBGs indicated in the joint FDRA field/indication may include a total of 121 RBs divided such that no RBGs 625 overlap within the BW for RA. That is, the network may configure a wider BW for RA in order to avoid a RBG 625 being shared by two adjacent carriers/cells. For example, the last RBG 625 of the first downlink transmission 605 may include five RBs, with the remaining three RBs being unused/unscheduled. The first RBG 625 of the second downlink transmission 610 may include four unused/unscheduled RBs, with the last four RBs being allocated for the second downlink transmission 610. The last RBG 625 of the second downlink transmission 610 may include five RBs, with the remaining there RBs being unused/unscheduled. The first RBG 625 of the third downlink transmission 615 may include four unused/unscheduled RBs, with the last four RBs being allocated for the third downlink transmission 615. Lastly, the first RBG 625 of the fourth downlink transmission 620 may include four unused/unscheduled RBs, with the remaining four RBs being allocated to the fourth downlink transmission 620.

Thus, the extended bandwidth being signaled in the joint FDRA field/indication may span an additional 21 RBs, but may prevent any carrier/cell (e.g., any downlink transmission) from having RBs within a single RBG 625.

Turning next to FRDA configuration 600-b of FIG. 6B, the multi-cell downlink transmissions may be scheduled across four carriers/cells. For example, a first downlink transmission 605 may be scheduled across CC0 that spans 5 MHz in the frequency domain, a second downlink transmission 610 may be scheduled across CC1 that spans 5 MHz, a third downlink transmission 615 may be scheduled across CC2 that spans 5 MHz, and a fourth downlink transmission 620 may be scheduled across CC3 that spans 5 MHz. Conventionally, the FDRA fields/indications for each downlink transmission would indicate that each downlink transmission includes 25 RBs, with two RBs being included in each RBG 625. The FDRA fields/indications may also indicate that the FDRA field/indication is a FDRA type 0 for all of the downlink transmissions. Each FDRA field/indication for any given downlink transmission would use 13 bits to indicate this information, with the total number of bits used in the control message being the multiple of the number of scheduled carriers/cells (e.g., 4 downlink transmission×13 bits per downlink transmission=52 bits being used in the control message).

However, defining the BW for RA according to the techniques describe herein include a joint FDRA field/indication being provided in the control message. The joint FDRA field/indication may indicate that downlink transmission may be defined based on the BW for RA that includes 113 RBs, with eight RBs being included in each RBG 625. The joint FDRA field/indication may also indicate that the FDRA field/indication is a FDRA type 0. Using this approach, the joint FDRA field/indication scheduling the downlink transmission would use 15 bits in total to indicate this information.

Thus, in this example where there are four carriers/cells scheduled with each having 25 RBs, the total of 25×4=100 RBs plus 13 additional RBs are treated as the BW for RA (e.g., the extended bandwidth). Then, for the BW for RA, the joint FDRA field/indication may indicate the FDRA information for the multi-cell downlink transmissions. Accordingly, the UE may identify the extended bandwidth (e.g., the BW for RA) spanning the set of RBGs for some or all (e.g., two or more) of the carriers/cells and then identify the set of RBGs based on the joint FDRA field/indication.

For example and as is illustrated in FIG. 6B, the set of RBGs indicated in the joint FDRA field/indication may include a total of 113 RBs divided such that some, but not all, RBGs 625 overlap within the BW for RA. That is, the network may configure a wider BW for RA in order to minimize the instances of an RBG 625 being shared by two adjacent carriers/cells. For example, the last RBG 625 of the first downlink transmission 605 may include five RBs, with the remaining three RBs being allocated as the first RBG 625 of the second downlink transmission 610. The last RBG 625 of the second downlink transmission 610 may include six RBs, with the remaining two RBs being unused/unscheduled. The first RBG 625 of the third downlink transmission 615 may include four unused/unscheduled RBs, with the last four RBs being allocated for the third downlink transmission 615. Lastly, the first RBG 625 of the fourth downlink transmission 620 may include four unused/unscheduled RBs, with the remaining four RBs being allocated to the fourth downlink transmission 620.

Thus, the extended bandwidth being signaled in the joint FDRA field/indication may span an additional 13 RBs, but may mitigate the instances where any carriers/cells (e.g., any downlink transmission) have RBs within a single RBG 625. In some aspects, the RBs for each carrier may be contiguous in the BW for RA, but the starting RB can be configurable anywhere (but carriers do not overlap). For example, the network may configure it so that starting/ending RBGs 625 have similar number of RBs, that the RBG grid in a carrier is aligned with legacy UEs, and the like.

Accordingly, the UE may identify or otherwise determine the number of RBs associated with some or all (e.g., two or more) of the carriers and then identify or otherwise determine the RBG size based on the number of RBs. This may include the RBG size being determined based on the number of RBs in the BW for RA (e.g., extending existing FDRA tables for the RBG sizes given the number of RBs per bandwidth). This may include the RBG size being determined based on the UE receiving an indication of the RBG size (e.g., by RRC signaling indicating RBG sizes of {2, 4, 8, 16, 24, 32, 48, 64, etc.} RBs per RBG 625).

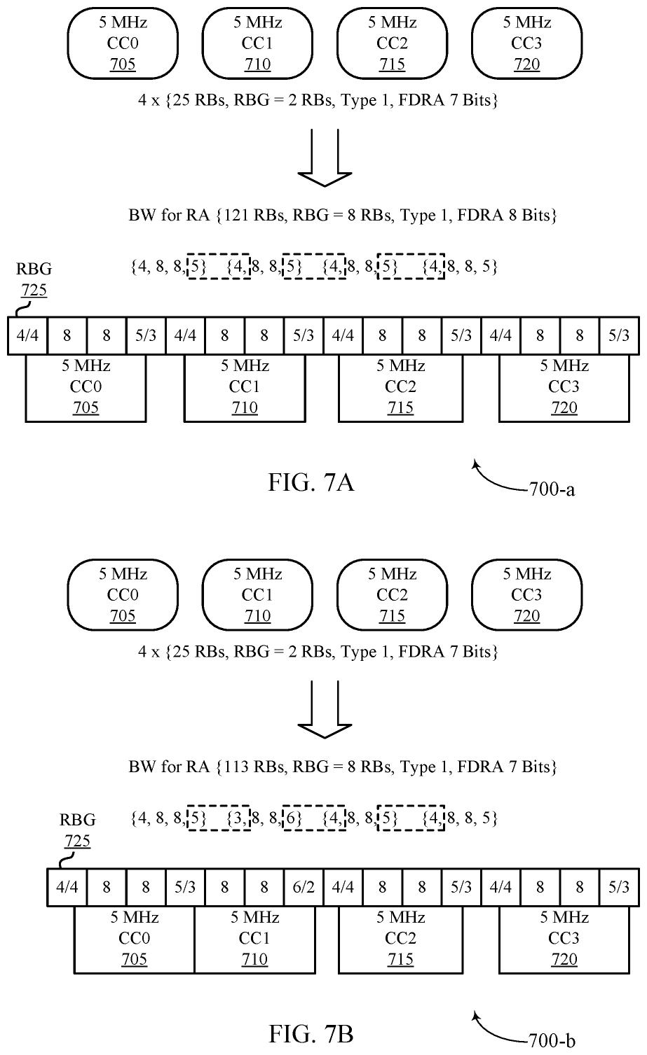

FIGS. 7A and 7B illustrate an example of a FDRA configuration 700 that supports FDRA for multi-cell scheduling in accordance with one or more aspects of the present disclosure. FDRA configuration 700 may implement aspects of wireless communications systems 100 and/or 200. Aspects of FDRA configuration 700 may be implemented at or implemented by a UE and/or network entity, which may be examples of the corresponding devices described herein.

Aspects of the techniques described herein provide a mechanism to schedule a UE for multi-cell downlink transmissions across a set of carriers/cells. In some examples, some or all (e.g., two or more) of the carriers/cells scheduled for the multi-cell downlink transmissions may be associated with a different downlink transmission. The UE may receive a control message scheduling the multi-cell downlink transmissions (e.g., a DCI). The control message may carry or otherwise convey FDRA information for the set of RBGs for some or all (e.g., two or more) of the carriers/cells scheduled for the downlink transmissions. Accordingly, the UE may receive the multi-cell downlink transmissions based on the control message (e.g., according to the FDRA information).

As discussed above, in some examples the control message may carry or otherwise convey a single FDRA field/indication for some or all (e.g., two or more) scheduled carriers/cells. That is, for each (e.g., some or all) carrier/cell being scheduled for a downlink transmission to the UE, the control message may carry or otherwise provide a single or joint FDRA field/indication. The joint FDRA configuration indicated for the cells/carriers being scheduled may indicate various information, such as the RA type (e.g., FDRA type 0 or FDRA type 1), the RBG size, etc.

In some aspects, this may include the BW for RA being configured. For example, the RBs (e.g., physical RBs) for multiple carriers/cells may be considered as non-contiguous RBs and the non-contiguous RBs may be treated as the BW for RA. In some examples, the multiple carriers/cells may not necessarily be mapped to the same RB grid physically (e.g., different carriers may have different point A references).

The non-limiting examples illustrated in FIG. 7 use a BW for RA that is configured to have a wider (e.g., extended) bandwidth than is necessary. In this example, the RBs of each carrier/cell may be mapped onto any non-overlapping portion of the BW for RA. Generally, the FDRA configuration 700 illustrated in FIG. 7 may be used for FDRA type 1. That is, the techniques discussed above regarding the BW for RA may applicable to a FDRA type 1 scenario where the joint FDRA indicates FDRA type 1. When the RBG size is greater than one RB for the RA, the network may in some examples avoid shared RBGs 725 between carriers at the cost of a DCI size increase (e.g., more bits) or may avoid the DCI size increase by allowing shared RBGs 725.

Turning first to FDRA configuration 700-a of FIG. 7A, the multi-cell downlink transmissions may be scheduled across four carriers/cells. For example, a first downlink transmission 705 may be scheduled across CC0 that spans 5 MHz in the frequency domain, a second downlink transmission 710 may be scheduled across CC1 that spans 5 MHz, a third downlink transmission 715 may be scheduled across CC2 that spans 5 MHz, and a fourth downlink transmission 720 may be scheduled across CC3 that spans 5 MHz. Conventionally, the FDRA fields/indications for each downlink transmission would indicate that each downlink transmission includes 25 RBs, with two RBs being included in each RBG 725. The FDRA fields/indications may also indicate that the FDRA field/indication is a FDRA type 1 for all of the downlink transmissions. Each FDRA field/indication for any given downlink transmission would use seven bits to indicate this information, with the total number of bits used in the control message being the multiple of the number of scheduled carriers/cells (e.g., 4×7=28 bits being used in the control message).

However, defining the BW for RA according to the techniques describe herein include a joint FDRA field/indication being provided in the control message. The joint FDRA field/indication may indicate that downlink transmission may be defined based on the BW for RA that includes 121 RBs, with eight RBs being included in each RBG 725. The joint FDRA field/indication may also indicate that the FDRA field/indication is a FDRA type 1. Using this approach, the joint FDRA field/indication scheduling the downlink transmission would use eight bits in total to indicate this information.

Thus, in this example where there are four carriers/cells scheduled with each having 25 RBs, the total of 25×4=100 RBs plus 21 additional RBs are treated as the BW for RA (e.g., the extended bandwidth). Then, for the BW for RA, the joint FDRA field/indication may indicate the FDRA information for the multi-cell downlink transmissions. Accordingly, the UE may identify the extended bandwidth (e.g., the BW for RA) spanning the set of RBGs for some or all (e.g., two or more) of the carriers/cells and then identify the set of RBGs based on the joint FDRA field/indication.

For example and as is illustrated in FIG. 7A, the set of RBGs indicated in the joint FDRA field/indication may include a total of 121 RBs divided such that no RBGs 725 overlap within the BW for RA. That is, the network may configure a wider BW for RA in order to avoid a RBG 725 being shared by two adjacent carriers/cells. For example, the last RBG 725 of the first downlink transmission 705 may include five RBs, with the remaining three RBs being unused/unscheduled. The first RBG 725 of the second downlink transmission 710 may include four unused/unscheduled RBs, with the last four RBs being allocated for the second downlink transmission 710. The last RBG 725 of the second downlink transmission 710 may include five RBs, with the remaining there RBs being unused/unscheduled. The first RBG 725 of the third downlink transmission 715 may include four unused/unscheduled RBs, with the last four RBs being allocated for the third downlink transmission 715. Lastly, the first RBG 725 of the fourth downlink transmission 720 may include five unused/unscheduled RBs, with the remaining three RBs being allocated to the fourth downlink transmission 720.

Thus, the extended bandwidth being signaled in the joint FDRA field/indication may span an additional 21 RBs, but may prevent any carrier/cell (e.g., any downlink transmission) from having RBs within a single RBG 725.

Turning next to FRDA configuration 700-b of FIG. 7B, the multi-cell downlink transmissions may be scheduled across four carriers/cells. For example, a first downlink transmission 705 may be scheduled across CC0 that spans 5 MHz in the frequency domain, a second downlink transmission 710 may be scheduled across CC1 that spans 5 MHz, a third downlink transmission 715 may be scheduled across CC2 that spans 5 MHz, and a fourth downlink transmission 720 may be scheduled across CC3 that spans 5 MHz. Conventionally, the FDRA fields/indications for each downlink transmission would indicate that each downlink transmission includes 25 RBs, with two RBs being included in each RBG 725. The FDRA fields/indications may also indicate that the FDRA field/indication is a FDRA type 1 for all of the downlink transmissions. Each FDRA field/indication for any given downlink transmission would use seven bits to indicate this information, with the total number of bits used in the control message being the multiple of the number of scheduled carriers/cells (e.g., 4 downlink transmission×7 bits per downlink transmission=28 bits being used in the control message).

However, defining the BW for RA according to the techniques describe herein include a joint FDRA field/indication being provided in the control message. The joint FDRA field/indication may indicate that downlink transmission may be defined based on the BW for RA that includes 113 RBs, with eight RBs being included in each RBG 725. The joint FDRA field/indication may also indicate that the FDRA field/indication is a FDRA type 1. Using this approach, the joint FDRA field/indication scheduling the downlink transmission would use seven bits in total to indicate this information.

Thus, in this example where there are four carriers/cells scheduled with each having 25 RBs, the total of 25×4=100 RBs plus 13 additional RBs are treated as the BW for RA (e.g., the extended bandwidth). Then, for the BW for RA, the joint FDRA field/indication may indicate the FDRA information for the multi-cell downlink transmissions. Accordingly, the UE may identify the extended bandwidth (e.g., the BW for RA) spanning the set of RBGs for some or all (e.g., two or more) of the carriers/cells and then identify the set of RBGs based on the joint FDRA field/indication.

For example and as is illustrated in FIG. 7B, the set of RBGs indicated in the joint FDRA field/indication may include a total of 113 RBs divided such that some, but not all, RBGs 725 overlap within the BW for RA. That is, the network may configure a wider BW for RA in order to minimize the instances of an RBG 725 being shared by two adjacent carriers/cells. For example, the last RBG 725 of the first downlink transmission 705 may include five RBs, with the remaining three RBs being allocated as the first RBG 725 of the second downlink transmission 710. The last RBG 725 of the second downlink transmission 710 may include six RBs, with the remaining two RBs being unused/unscheduled. The first RBG 725 of the third downlink transmission 715 may include four unused/unscheduled RBs, with the last four RBs being allocated for the third downlink transmission 715. Lastly, the first RBG 725 of the fourth downlink transmission 720 may include four unused/unscheduled RBs, with the remaining four RBs being allocated to the fourth downlink transmission 720.

Thus, the extended bandwidth being signaled in the joint FDRA field/indication may span an additional 13 RBs, but may mitigate the instances where any carriers/cells (e.g., any downlink transmission) have RBs within a single RBG 725. In some aspects, the RBs for each carrier may be contiguous in the BW for RA, but the starting RB can be configurable anywhere (but carriers do not overlap). For example, the network may configure it so that starting/ending RBGs 725 have a similar number of RBs, that the RBG grid in a carrier is aligned with legacy UEs, and the like.

Accordingly, the UE may identify or otherwise determine the number of RBs associated with some or all (e.g., two or more) of the carriers and then identify or otherwise determine the RBG size based on the number of RBs. This may include the RBG size being determined based on the number of RBs in the BW for RA (e.g., extending existing FDRA tables for the RBG sizes given the number of RBs per bandwidth). This may include the RBG size being determined based on the UE receiving an indication of the RBG size (e.g., by RRC signaling indicating RBG sizes of {2, 4, 8, 16, 24, 32, 48, 64, etc.} RBs per RBG 725.

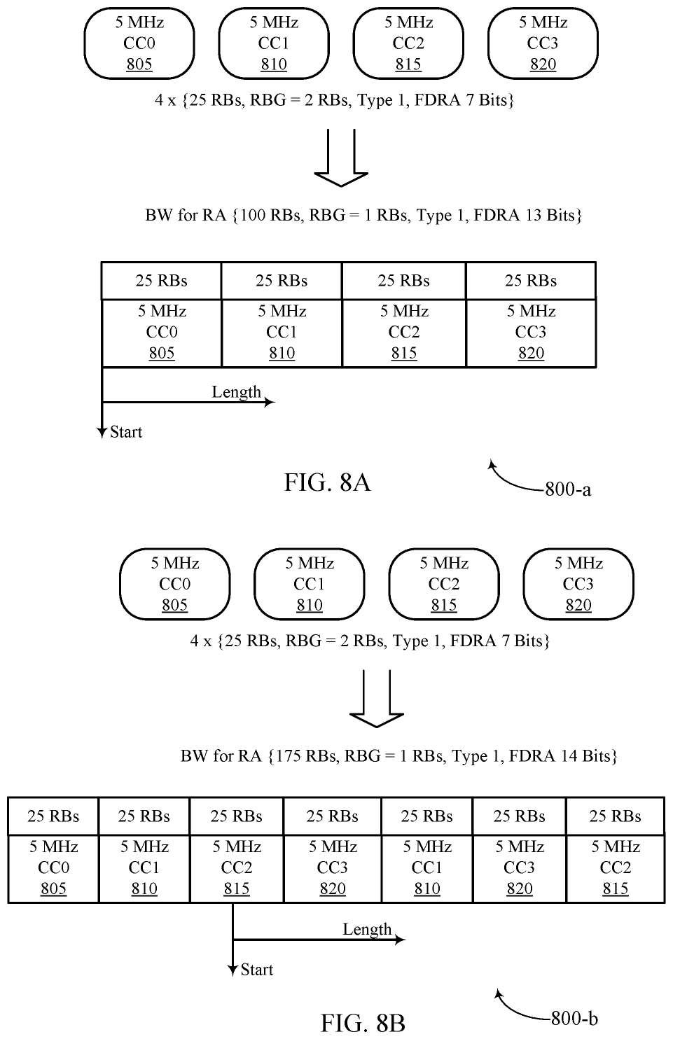

FIGS. 8A and 8B illustrate an example of a FDRA configuration 800 that supports FDRA for multi-cell scheduling in accordance with one or more aspects of the present disclosure. FDRA configuration 800 may implement aspects of wireless communications systems 100 and/or 200. Aspects of FDRA configuration 800 may be implemented at or implemented by a UE and/or network entity, which may be examples of the corresponding devices described herein.

FDRA configuration 800 generally illustrates an example implementation of the techniques described herein where the control message scheduling the multi-cell downlink transmissions for the UE uses the BW for RA techniques when a FDRA type 1 indication is used/conveyed. Aspects of FDRA configuration 800 may implement aspects of FDRA configuration 700, or vice versa.

For example and turning first to FDRA configuration 800-a of FIG. 8A, the multi-cell downlink transmissions may be scheduled across four carriers/cells. For example, a first downlink transmission 805 may be scheduled across CC0 that spans 5 MHz in the frequency domain, a second downlink transmission 810 may be scheduled across CC1 that spans 5 MHz, a third downlink transmission 815 may be scheduled across CC2 that spans 5 MHz, and a fourth downlink transmission 820 may be scheduled across CC3 that spans 5 MHz. Conventionally, the FDRA fields/indications for each downlink transmission would indicate that each downlink transmission includes 25 RBs, with two RBs being included in each RBG. The FDRA fields/indications may also indicate that the FDRA field/indication is a FDRA type 1 for all of the downlink transmissions. Each FDRA field/indication for any given downlink transmission would use seven bits to indicate this information, with the total number of bits used in the control message being the multiple of the number of scheduled carriers/cells (e.g., 4×7=28 bits being used in the control message).

However, defining the BW for RA according to the techniques describe herein include a joint FDRA field/indication being provided in the control message. The joint FDRA field/indication may indicate that the downlink transmissions may be defined based on the BW for RA that includes 100 RBs, with one RB being included in each RBG. The joint FDRA field/indication may also indicate that the FDRA field/indication is a FDRA type 1. Using this approach, the joint FDRA field/indication scheduling the downlink transmission would use 13 bits in total to indicate this information.

Thus, in this example where there are four carriers/cells scheduled with each having 25 RBs, the total of 25×4=100 RBs are treated as the BW for RA (e.g., the extended bandwidth in this example). Then, for the BW for RA, the joint FDRA field/indication may indicate the FDRA information for the multi-cell downlink transmissions. Accordingly, the UE may identify the extended bandwidth (e.g., the BW for RA) spanning the set of RBGs for some or all (e.g., two or more) of the carriers/cells and then identify the set of RBGs based on the joint FDRA field/indication.

As noted above, the FDRA type 1 scenario generally includes an indication of a starting RB as well as the number of RBs included in the RA. In the non-limiting example illustrated in FIG. 8A, this may include an indication of the starting RB associated with the first RB (or some other RB) associated with the carrier/cell having the lowest index (e.g., CC0) as well as an indication that there are 100 RBs included in the RA. Thus, the extended bandwidth being signaled in the joint FDRA field/indication may span the 100 RBs, but use less than half as many bits to convey the same information.

However, aspects of the techniques described herein may support the BW for RA being extended to resolve the contiguous RB limitation. One non-limiting example of this is illustrated in FDRA configuration 800-b of FIG. 8B.

Turning next to FRDA configuration 800-b of FIG. 8B, c defining the BW for RA according to the techniques describe herein in the FDRA type 1 scenario may include a joint FDRA field/indication being provided in the control message. The joint FDRA field/indication may indicate that downlink transmission may be defined based on the BW for RA that includes 175 RBs, with one RB being included in each RBG (although RBG sizes of greater than one may be used). The joint FDRA field/indication may also indicate that the FDRA field/indication is a FDRA type 1. Using this approach, the joint FDRA field/indication scheduling the downlink transmission would use 14 bits in total to indicate this information.

Thus, in this example where there are four carriers/cells scheduled with each having 25 RBs, the total of 25×4=100 RBs plus 75 additional RBs are treated as the BW for RA (e.g., the extended bandwidth). Then, for the BW for RA, the joint FDRA field/indication may indicate the FDRA information for the multi-cell downlink transmissions. Accordingly, the UE may identify the extended bandwidth (e.g., the BW for RA) spanning the set of RBGs for some or all (e.g., two or more) of the carriers/cells and then identify the set of RBGs based on the joint FDRA field/indication.

For example and as is illustrated in FIG. 8B, the set of RBGs indicated in the joint FDRA field/indication may include a total of 175 RBs. However, the network may configure (e.g., via the control message) the wider BW for RA and carrier(s)/cell(s) that are mapped multiple times within the BW for RA. This may enable the BW for RA being configured over non-contiguous carriers. In the non-limiting example illustrated in FIG. 8B, this may include the first downlink transmission 805 being scheduled on the first 25 RBs, the second downlink transmission 810 being scheduled on the second and fifth 25 RBs, the third downlink transmission 815 being scheduled on the third and last 25 RBs, and the fourth downlink transmission 820 being scheduled on the fourth and sixth 25 RBs. The UE may identify or otherwise determine the RBs/RBGs to use to receive the downlink transmission based on the starting RB and number of RBs signaled in the FDRA field/indication.

That is, the UE may identify or otherwise determine the number of RBs associated with some or all (e.g., two or more) of the carriers and then identify or otherwise determine the RBG size based on the number of RBs. This may include the RBG size being determined based on the number of RBs in the BW for RA (e.g., extending existing FDRA tables for the RBG sizes given the number of RBs per bandwidth). This may include the RBG size being determined based on the UE receiving an indication of the RBG size (e.g., by RRC signaling indicating RBG sizes of {2, 4, 8, 16, 24, 32, 48, 64, etc.} RBs per RBG.

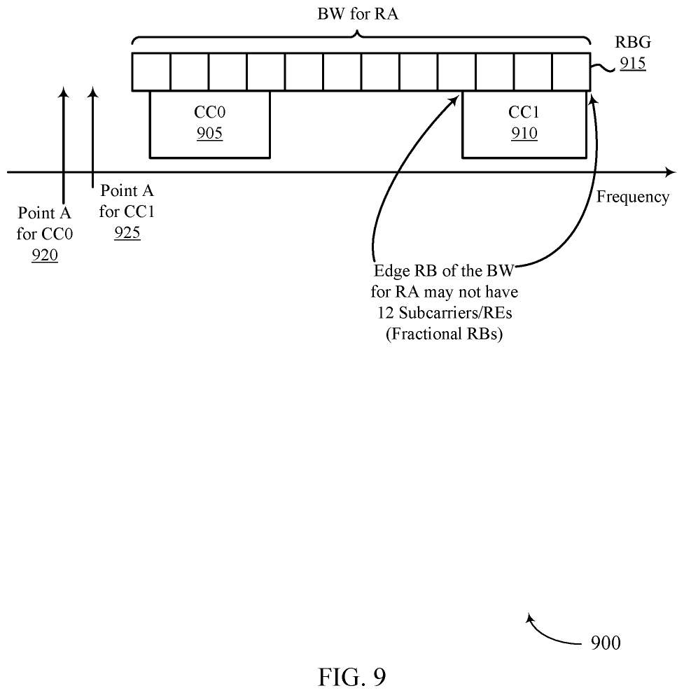

FIG. 9 illustrates an example of a FDRA configuration 900 that supports FDRA for multi-cell scheduling in accordance with one or more aspects of the present disclosure. FDRA configuration 900 may implement aspects of wireless communications systems 100 and/or 200. Aspects of FDRA configuration 900 may be implemented at or implemented by a UE and/or network entity, which may be examples of the corresponding devices described herein.

Aspects of the techniques described herein provide a mechanism to schedule a UE for multi-cell downlink transmissions across a set of carriers/cells. In some examples, some or all (e.g., two or more) of the carriers/cells scheduled for the multi-cell downlink transmissions may be associated with a different downlink transmission. The UE may receive a control message scheduling the multi-cell downlink transmissions (e.g., a DCI). The control message may carry or otherwise convey FDRA information for the set of RBGs for some or all (e.g., two or more) of the carriers/cells scheduled for the downlink transmissions. Accordingly, the UE may receive the multi-cell downlink transmissions based on the control message (e.g., according to the FDRA information).

In some examples, the control message may carry or otherwise convey a single FDRA field/indication for some or all (e.g., two or more) scheduled carriers/cells. That is, for each (e.g., some or all) carrier/cell being scheduled for a downlink transmission to the UE, the control message may carry or otherwise provide a single or common FDRA field/indication. The common FDRA configuration indicated for the cells/carriers being scheduled may indicate various information, such as the RA type (e.g., FDRA type 0 or FDRA type 1), the RBG size, etc.

In some aspects, this may include the BW for RA being configured. For example, the RBs (e.g., physical RBs) for multiple carriers/cells may be considered as non-contiguous RBs and the non-contiguous RBs may be treated as the BW for RA. In some examples, the multiple carriers/cells may not necessarily be mapped to the same RB grid physically (e.g., different carriers may have different point A references).

That is, aspects of the techniques described herein may include defining/configuring the BW for RA that is common across the carriers/cells in a physical manner. The frequency gap between two carriers are considered as unused/unscheduled RE(s)/RB(s)/RBG(s) within the BW for RA (e.g., gap resource(s)). In some aspects, mapping the carrier into the RB/RBG grid may be deterministic by the physical center frequency/bandwidth. However, different carriers may have different point A references. For example, the multi-cell downlink transmissions may include a first downlink transmission 905 scheduled on a first carrier/cell (e.g., CC0) and a second downlink transmission 910 scheduled on a second carrier/cell (e.g., CC1). The control message may include a common/joint FDRA field/indication that identifies the RBG(s) 915 included in the BW for RA.

However, CC0 may be associated with a first point A 920 that is different (e.g., in the physical frequency domain) from a second point A 925 associated with CC1. Accordingly, if the RB/RBG grid of the BW for RA is generated based on the first point A 920 of CC0, then the RB/RBG grid of CC1 may not be aligned. Accordingly, an edge of a carrier may not be the edge of a RBG. In some examples, the edge of a carrier may not have 12 REs (e.g., may be a fractional RB), which may occur when the point A is not the same between two carriers configured or otherwise scheduled by the BW for RA.

Accordingly, aspects of the techniques described herein may support a fractional RB (e.g., a RB having less than 12 subcarriers/REs) being defined. The RBG including the fractional RB may have (e.g., N−1) RBs plus one fractional RB (e.g., if N is greater than one). That is, the common RA bandwidth (e.g., the BW for RA including gap RB(s) between carriers) may include a fractional RB for at least one carrier (e.g., CC1 in this example).

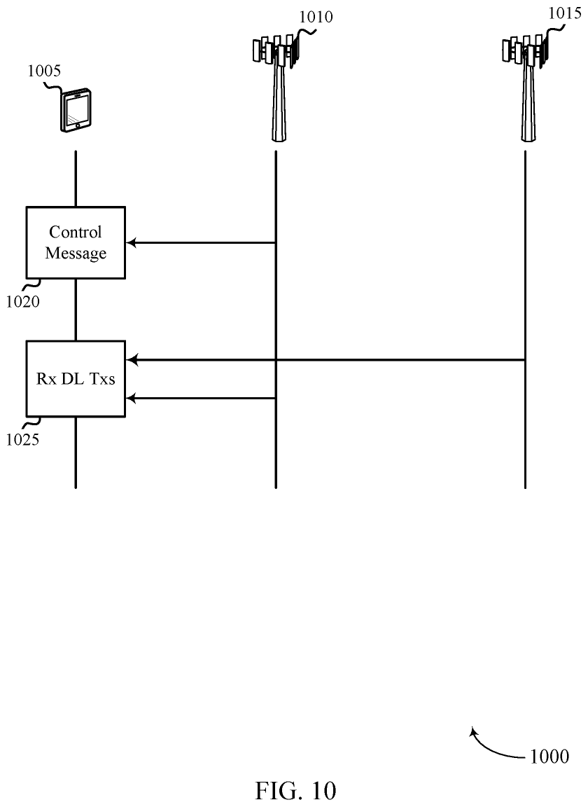

FIG. 10 illustrates an example of a method 1000 that supports FDRA for multi-cell scheduling in accordance with one or more aspects of the present disclosure. Method 1000 may implement aspects of wireless communications systems 100 and/or 200 and/or aspects of FDRA configurations 300-900. Aspects of method 1000 may be implemented at or implemented by UE 1005, network entity 1010, and/or network entity 1015, which may be examples of the corresponding devices described herein. In some aspects, network entity 1010 may be an example of a scheduling entity scheduling multi-cell downlink transmissions to UE 1005, with network entity 1010 and/or network entity 1015 representing a cell/carrier performing a downlink transmission.

At 1020, UE 1005 may receive or otherwise obtain a control message. In some examples, UE 1005 may receive the control message from a scheduling entity, such as network entity 1010. In some examples, the control message may be a DCI. In some examples, the control message may schedule communications for UE 1005. In some examples, the control message may schedule multi-cell downlink transmissions for UE 1005. In some examples, the multi-cell downlink transmissions may be scheduled over a set of carriers/cells. In some examples, some or all (e.g., at least two, or two or more) carriers/cells in the set of carriers/cells may be associated with a different downlink transmission. In some examples, the control message may include a FDRA information. In some examples, the FDRA information may be for a set of RBGs. In some examples, the set of RBGs may be for some or all (e.g., at least two, two or more) carriers/cells in the set of carriers/cells.

In some examples, the control message may include the FDRA information according to a common FDRA type. For example, the FDRA information may include multiple FDRA fields/indications. In some examples, each FDRA field/indication carried in the control message may indicate the same FDRA type (e.g., FDRA type 0 or FDRA type 1) for the multi-cell downlink transmissions. In some examples, each or some FDRA field(s)/indication(s) carried in the control message may indicate different FDRA types (e.g., FDRA type 0 and FDRA type 1) for the multi-cell downlink transmissions.

In some examples, the control message may include a common or joint (e.g., a single) FDRA field/indication for the multi-cell downlink transmissions. In some examples, the common or joint FDRA field/indication may include a BW for RA. In some examples, the BW for RA may span the RBs of the carriers in the multi-cell downlink transmissions (e.g., the original bandwidth of the carriers). In some examples, the BW for RA may be span the RBs of the carriers and include additional RBs (e.g., an extended bandwidth).

At 1025, UE 1005 may receive or otherwise obtain the downlink transmissions scheduled in the multi-cell downlink transmissions. In some examples, UE 1005 may receive the downlink transmissions according to the FDRA information indicated in the control message. For example, UE 1005 may receive a first downlink transmission of the multi-cell downlink transmissions from network entity 1010 and receive a second downlink transmission of the multi-cell downlink transmissions from network entity 1015.

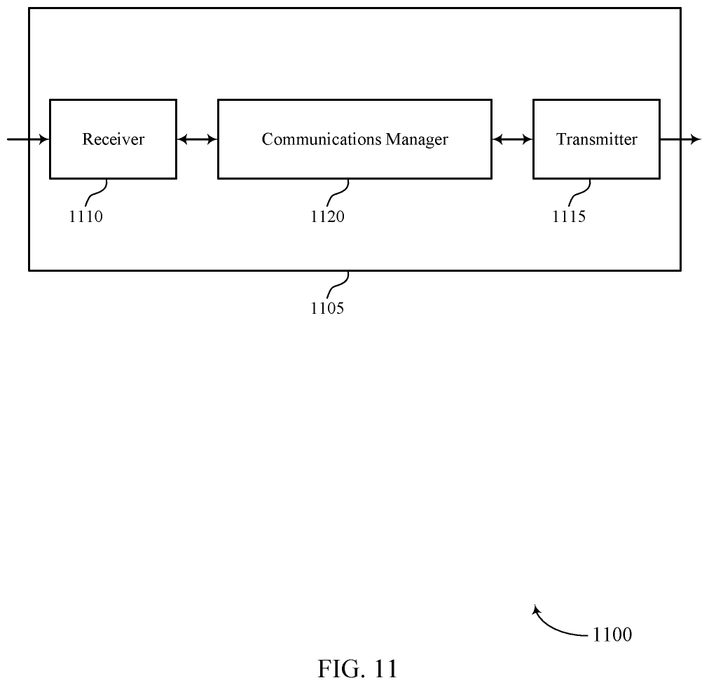

FIG. 11 shows a block diagram 1100 of a device 1105 that supports FDRA for multi-cell scheduling in accordance with one or more aspects of the present disclosure. The device 1105 may be an example of aspects of a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to FDRA for multi-cell scheduling). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to FDRA for multi-cell scheduling). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of FDRA for multi-cell scheduling as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a UE in accordance with examples as disclosed herein. For example, the communications manager 1120 may be configured as or otherwise support a means for receiving a control message scheduling multi-cell downlink transmissions over a set of carriers, at least two carriers in the set of carriers being associated with different downlink transmissions of the multi-cell downlink transmissions, the control message including FDRA information for a set of RBGs for the at least two carriers in the set of carriers for the multi-cell downlink transmissions. The communications manager 1120 may be configured as or otherwise support a means for receiving the multi-cell downlink transmissions according to the FDRA information.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for scheduling multi-cell downlink transmissions over a set of carriers using separate or a joint FDRA field/indication in the control message (e.g., the scheduling DCI).

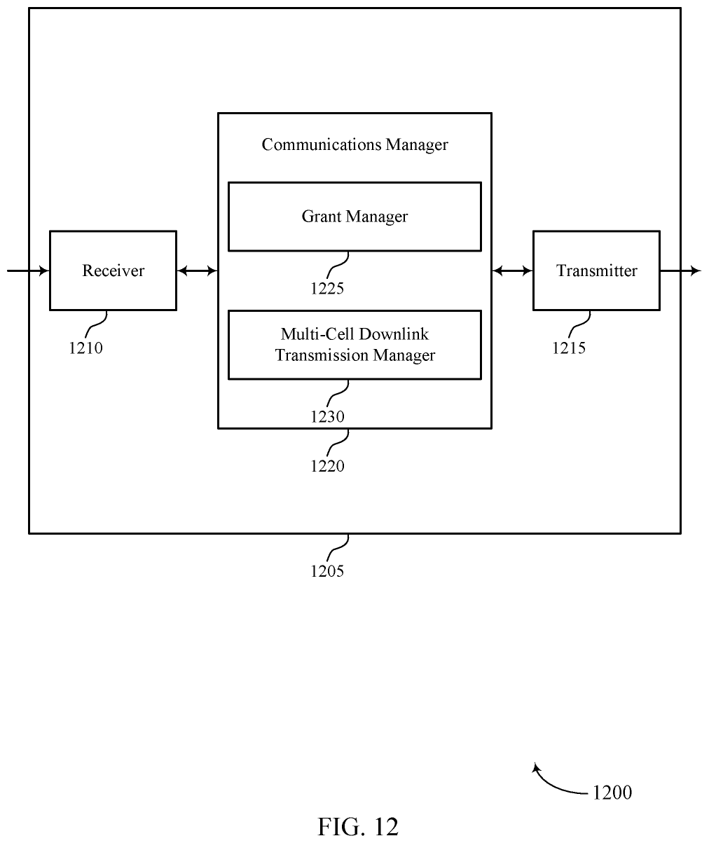

FIG. 12 shows a block diagram 1200 of a device 1205 that supports FDRA for multi-cell scheduling in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to FDRA for multi-cell scheduling). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to FDRA for multi-cell scheduling). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of FDRA for multi-cell scheduling as described herein. For example, the communications manager 1220 may include a grant manager 1225 a multi-cell downlink transmission manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a UE in accordance with examples as disclosed herein. The grant manager 1225 may be configured as or otherwise support a means for receiving a control message scheduling multi-cell downlink transmissions over a set of carriers, at least two carriers in the set of carriers being associated with different downlink transmissions of the multi-cell downlink transmissions, the control message including FDRA information for a set of RBGs for the at least two carriers in the set of carriers for the multi-cell downlink transmissions. The multi-cell downlink transmission manager 1230 may be configured as or otherwise support a means for receiving the multi-cell downlink transmissions according to the FDRA information.

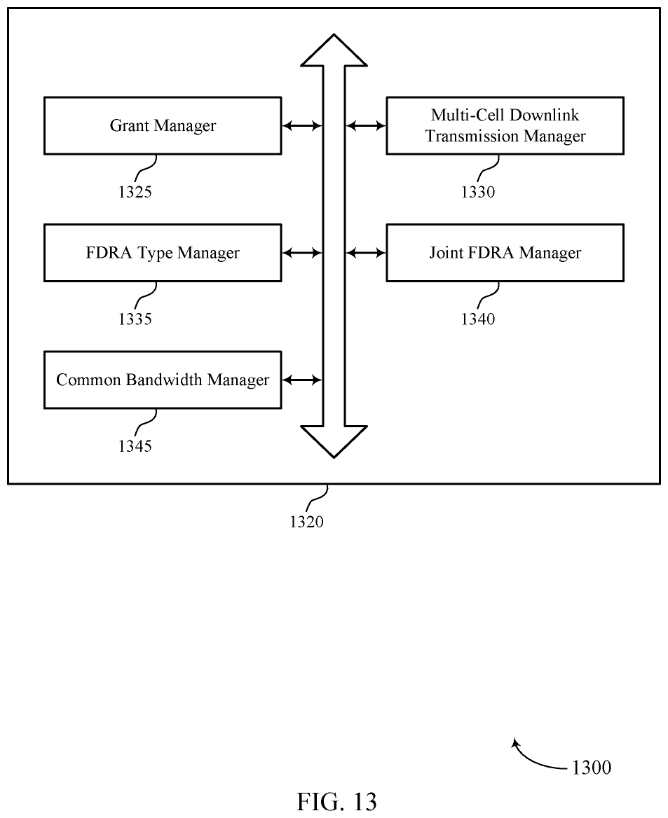

FIG. 13 shows a block diagram 1300 of a communications manager 1320 that supports FDRA for multi-cell scheduling in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of FDRA for multi-cell scheduling as described herein. For example, the communications manager 1320 may include a grant manager 1325, a multi-cell downlink transmission manager 1330, an FDRA type manager 1335, a joint FDRA manager 1340, a common bandwidth manager 1345, or any combination thereof. Each of these components may communicate, directly or indirectly, with one another (e.g., via one or more buses).

The communications manager 1320 may support wireless communications at a UE in accordance with examples as disclosed herein. The grant manager 1325 may be configured as or otherwise support a means for receiving a control message scheduling multi-cell downlink transmissions over a set of carriers, at least two carriers in the set of carriers being associated with different downlink transmissions of the multi-cell downlink transmissions, the control message including FDRA information for a set of RBGs for the at least two carriers in the set of carriers for the multi-cell downlink transmissions. The multi-cell downlink transmission manager 1330 may be configured as or otherwise support a means for receiving the multi-cell downlink transmissions according to the FDRA information.

In some examples, the FDRA type manager 1335 may be configured as or otherwise support a means for receiving, via the control message, the FDRA information for the at least two carriers according to a configured FDRA type that is common to the at least two carriers in the set of carriers.

In some examples, the FDRA type manager 1335 may be configured as or otherwise support a means for receiving, via the control message, the FDRA information for the at least two carriers according to a FDRA type that is separately configured for the at least two carriers. In some examples, the set of RBGs are associated with a RBG size of at least one of 24, 32, 48, 64, or all RBs within a BWP, RBs-per-RBG.

In some examples, the joint FDRA manager 1340 may be configured as or otherwise support a means for receiving, via the control message, the FDRA information for the at least two carriers according to a joint FDRA field of the control message. In some examples, the joint FDRA manager 1340 may be configured as or otherwise support a means for identifying a combined bandwidth spanning the set of RBGs for the at least two carriers in the set of carriers. In some examples, the joint FDRA manager 1340 may be configured as or otherwise support a means for identifying the set of RBGs for the at least two carriers in the set of carriers based on the joint FDRA field of the control message and the combined bandwidth. In some examples, the control message identifies at least one of a starting RBG associated with a first carrier in the set of carriers, a last RBG associated with a last carrier in the set of carriers, or both.

In some examples, the joint FDRA manager 1340 may be configured as or otherwise support a means for identifying an extended bandwidth exceeding a span of the set of RBGs for the at least two carriers in the set of carriers. In some examples, the joint FDRA manager 1340 may be configured as or otherwise support a means for identifying the set of RBGs for the at least two carriers in the set of carriers based on the joint FDRA field of the control message and the extended bandwidth. In some examples, the joint FDRA manager 1340 may be configured as or otherwise support a means for identifying a number of RBs associated with the at least two carriers in the set of carriers. In some examples, the joint FDRA manager 1340 may be configured as or otherwise support a means for identifying a RBG size for the at least two carriers in the set of carriers based on the number of RBs, where the set of RBGs for the at least two carriers in the set of carriers is based on the RBG size and the number of RBs.

In some examples, the joint FDRA manager 1340 may be configured as or otherwise support a means for receiving an indication of a RBG size for the at least two carriers in the set of carriers.

In some examples, the common bandwidth manager 1345 may be configured as or otherwise support a means for determining, based on the FDRA information in the control message, a common resource allocation bandwidth to be applied across the at least two carriers in the set of carriers, where the common resource allocation bandwidth defines an extended bandwidth spanning the at least two carriers and one or more gap RBs between the at least two carriers. In some examples, the common resource allocation bandwidth includes a fractional RB for at least one carrier in the set of carriers.

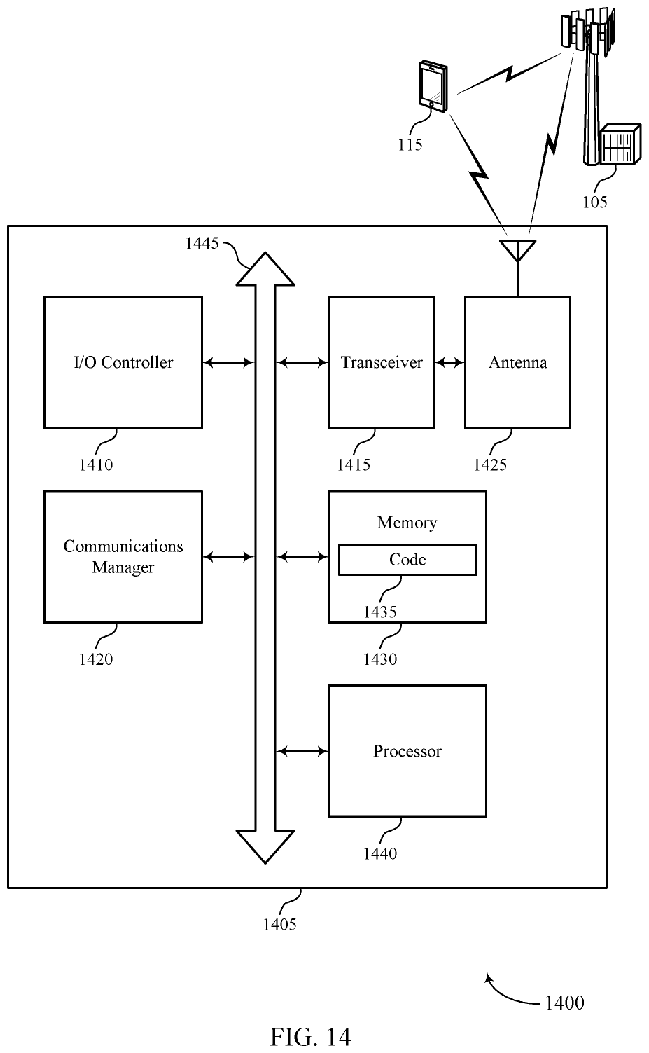

FIG. 14 shows a diagram of a system 1400 including a device 1405 that supports FDRA for multi-cell scheduling in accordance with one or more aspects of the present disclosure. The device 1405 may be an example of or include the components of a device 1105, a device 1205, or a UE 115 as described herein. The device 1405 may communicate (e.g., wirelessly) with one or more network entities 105, one or more UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting FDRA for multi-cell scheduling). For example, the device 1405 or a component of the device 1405 may include a processor 1440 and memory 1430 coupled with or to the processor 1440, the processor 1440 and memory 1430 configured to perform various functions described herein.

The communications manager 1420 may support wireless communications at a UE in accordance with examples as disclosed herein. For example, the communications manager 1420 may be configured as or otherwise support a means for receiving a control message scheduling multi-cell downlink transmissions over a set of carriers, at least two carriers in the set of carriers being associated with different downlink transmissions of the multi-cell downlink transmissions, the control message including FDRA information for a set of RBGs for the at least two carriers in the set of carriers for the multi-cell downlink transmissions. The communications manager 1420 may be configured as or otherwise support a means for receiving the multi-cell downlink transmissions according to the FDRA information.

By including or configuring the communications manager 1420 in accordance with examples as described herein, the device 1405 may support techniques for scheduling multi-cell downlink transmissions over a set of carriers using separate or a joint FDRA field/indication in the control message (e.g., the scheduling DCI).

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of FDRA for multi-cell scheduling as described herein, or the processor 1440 and the memory 1430 may be otherwise configured to perform or support such operations.

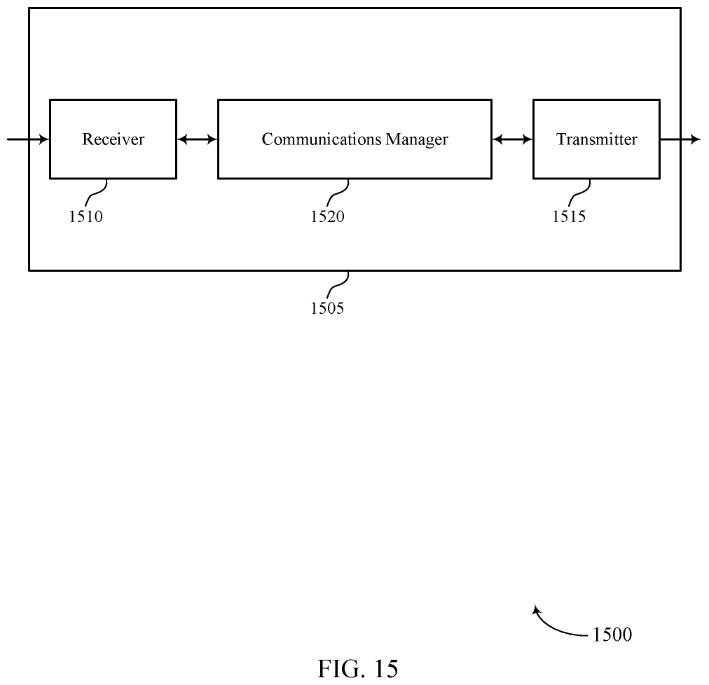

FIG. 15 shows a block diagram 1500 of a device 1505 that supports FDRA for multi-cell scheduling in accordance with one or more aspects of the present disclosure. The device 1505 may be an example of aspects of a network entity 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The communications manager 1520, the receiver 1510, the transmitter 1515, or various combinations thereof or various components thereof may be examples of means for performing various aspects of FDRA for multi-cell scheduling as described herein. For example, the communications manager 1520, the receiver 1510, the transmitter 1515, or various combinations or components thereof may support a method for performing one or more of the functions described herein.

In some examples, the communications manager 1520, the receiver 1510, the transmitter 1515, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1520, the receiver 1510, the transmitter 1515, or various combinations or components thereof may be implemented in code (e.g., as communications management software or firmware) executed by a processor. If implemented in code executed by a processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications at a network entity in accordance with examples as disclosed herein. For example, the communications manager 1520 may be configured as or otherwise support a means for transmitting a control message scheduling multi-cell downlink transmissions for a UE over a set of carriers, at least two carriers in the set of carriers being associated with different downlink transmissions of the multi-cell downlink transmissions, the control message indicating FDRA information for a set of RBGs for the at least two carriers in the set of carriers for the multi-cell downlink transmissions. The communications manager 1520 may be configured as or otherwise support a means for transmitting the multi-cell downlink transmissions according to the FDRA information.

By including or configuring the communications manager 1520 in accordance with examples as described herein, the device 1505 (e.g., a processor controlling or otherwise coupled with the receiver 1510, the transmitter 1515, the communications manager 1520, or a combination thereof) may support techniques for scheduling multi-cell downlink transmissions over a set of carriers using separate or a joint FDRA field/indication in the control message (e.g., the scheduling DCI).

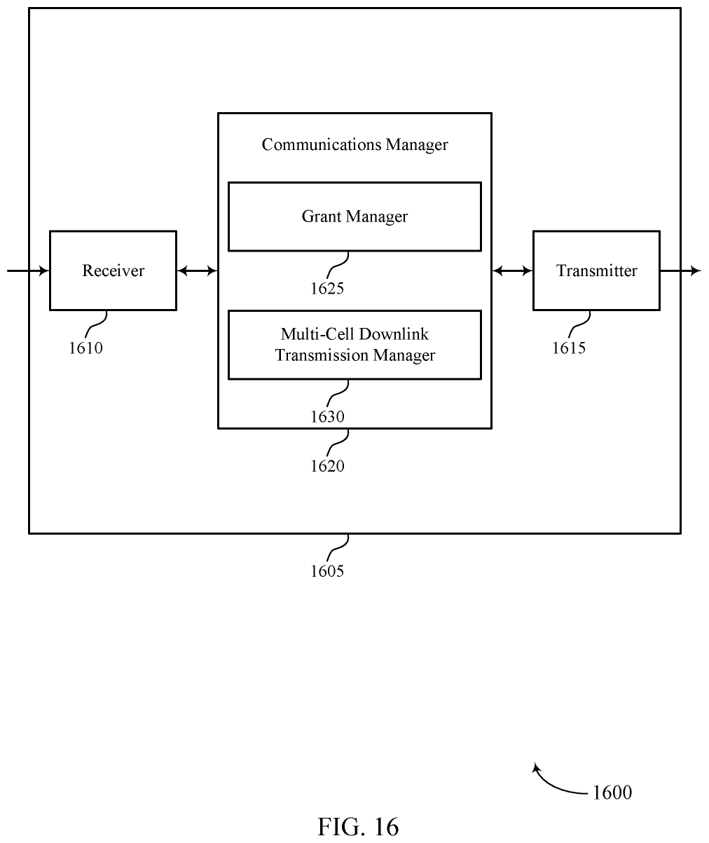

FIG. 16 shows a block diagram 1600 of a device 1605 that supports FDRA for multi-cell scheduling in accordance with one or more aspects of the present disclosure. The device 1605 may be an example of aspects of a device 1505 or a network entity 105 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The device 1605, or various components thereof, may be an example of means for performing various aspects of FDRA for multi-cell scheduling as described herein. For example, the communications manager 1620 may include a grant manager 1625 a multi-cell downlink transmission manager 1630, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications at a network entity in accordance with examples as disclosed herein. The grant manager 1625 may be configured as or otherwise support a means for transmitting a control message scheduling multi-cell downlink transmissions for a UE over a set of carriers, at least two carriers in the set of carriers being associated with different downlink transmissions of the multi-cell downlink transmissions, the control message indicating FDRA information for a set of RBGs for the at least two carriers in the set of carriers for the multi-cell downlink transmissions. The multi-cell downlink transmission manager 1630 may be configured as or otherwise support a means for transmitting the multi-cell downlink transmissions according to the FDRA information.

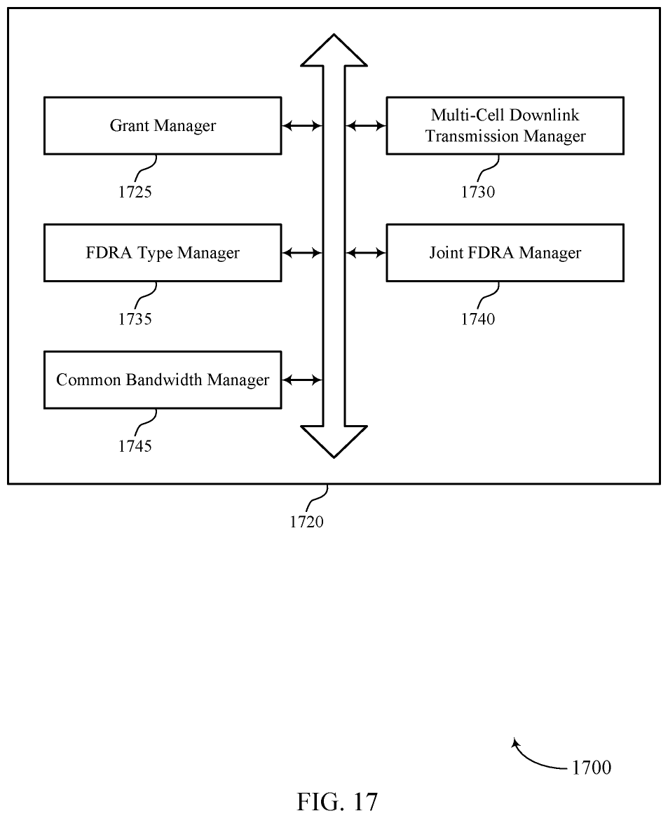

FIG. 17 shows a block diagram 1700 of a communications manager 1720 that supports FDRA for multi-cell scheduling in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of FDRA for multi-cell scheduling as described herein. For example, the communications manager 1720 may include a grant manager 1725, a multi-cell downlink transmission manager 1730, an FDRA type manager 1735, a joint FDRA manager 1740, a common bandwidth manager 1745, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1720 may support wireless communications at a network entity in accordance with examples as disclosed herein. The grant manager 1725 may be configured as or otherwise support a means for transmitting a control message scheduling multi-cell downlink transmissions for a UE over a set of carriers, at least two carriers in the set of carriers being associated with different downlink transmissions of the multi-cell downlink transmissions, the control message indicating FDRA information for a set of RBGs for the at least two carriers in the set of carriers for the multi-cell downlink transmissions. The multi-cell downlink transmission manager 1730 may be configured as or otherwise support a means for transmitting the multi-cell downlink transmissions according to the FDRA information.

In some examples, the FDRA type manager 1735 may be configured as or otherwise support a means for transmitting, via the control message, the FDRA information for the at least two carriers according to a configured FDRA type that is common to the at least two carriers in the set of carriers.

In some examples, the FDRA type manager 1735 may be configured as or otherwise support a means for transmitting, via the control message, the FDRA information for the at least two carriers according to a FDRA type that is separately configured for the at least two carriers in the set of carriers. In some examples, the set of RBGs are associated with a RBG size of at least one of 24, 32, 48, 64, or all RBs within a BWP, RBs-per-RBG, or a combination thereof.

In some examples, the joint FDRA manager 1740 may be configured as or otherwise support a means for transmitting, via the control message, the FDRA information for the at least two carriers according to a joint FDRA field of the control message. In some examples, the joint FDRA manager 1740 may be configured as or otherwise support a means for identifying a combined bandwidth spanning the set of RBGs for the at least two carriers in the set of carriers. In some examples, the joint FDRA manager 1740 may be configured as or otherwise support a means for identifying the set of RBGs for the at least two carriers in the set of carriers based on the joint FDRA field of the control message and the combined bandwidth. In some examples, the control message identifies at least one of a starting RBG associated with a first carrier in the set of carriers, a last RBG associated with a last carrier in the set of carriers, or both.

In some examples, the joint FDRA manager 1740 may be configured as or otherwise support a means for identifying an extended bandwidth exceeding a span of the set of RBGs for the at least two carriers in the set of carriers. In some examples, the joint FDRA manager 1740 may be configured as or otherwise support a means for identifying the set of RBGs for the at least two carriers in the set of carriers based on the joint FDRA field of the control message and the extended bandwidth.

In some examples, the joint FDRA manager 1740 may be configured as or otherwise support a means for transmitting an indication of a RBG size for the at least two carriers in the set of carriers, where the set of RBGs for the at least two carriers in the set of carriers is further based on the RBG size for the at least two carriers and a number of RBs associated with the at least two carriers in the set of carriers.

In some examples, the joint FDRA manager 1740 may be configured as or otherwise support a means for identifying a number of RBs associated with the at least two carriers in the set of carriers. In some examples, the joint FDRA manager 1740 may be configured as or otherwise support a means for identifying a RBG size for the at least two carriers in the set of carriers based on the number of RBs associated with the at least two carriers, where the set of RBGs for the at least two carriers in the set of carriers is further based on the RBG size for the at least two carriers in the set of carriers.

In some examples, the common bandwidth manager 1745 may be configured as or otherwise support a means for determining, based on the FDRA information in the control message, a common resource allocation bandwidth to be applied across the at least two carriers in the set of carriers, where the common resource allocation bandwidth defines an extended bandwidth spanning the at least two carriers and one or more gap RBs between the at least two carriers. In some examples, the common resource allocation bandwidth includes a fractional RB for at least one carrier in the set of carriers.

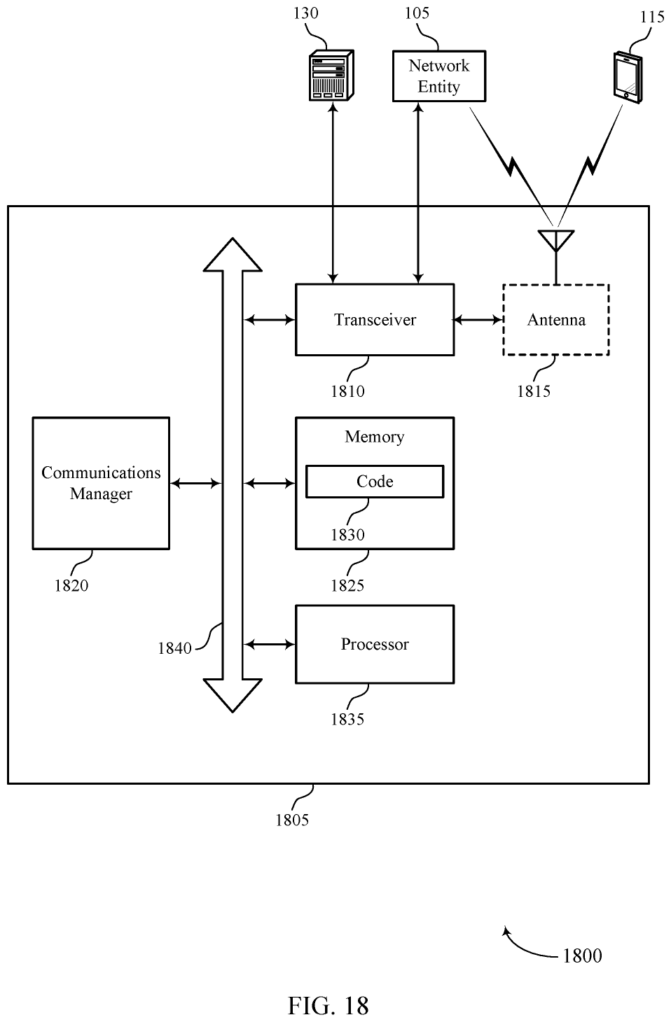

FIG. 18 shows a diagram of a system 1800 including a device 1805 that supports FDRA for multi-cell scheduling in accordance with one or more aspects of the present disclosure. The device 1805 may be an example of or include the components of a device 1505, a device 1605, or a network entity 105 as described herein. The device 1805 may communicate with one or more network entities 105, one or more UEs 115, or any combination thereof, which may include communications over one or more wired interfaces, over one or more wireless interfaces, or any combination thereof. The device 1805 may include components that support outputting and obtaining communications, such as a communications manager 1820, a transceiver 1810, an antenna 1815, a memory 1825, code 1830, and a processor 1835. These components may be in electronic communication or otherwise coupled (e.g., operatively, communicatively, functionally, electronically, electrically) via one or more buses (e.g., a bus 1840).

The transceiver 1810 may support bi-directional communications via wired links, wireless links, or both as described herein. In some examples, the transceiver 1810 may include a wired transceiver and may communicate bi-directionally with another wired transceiver. Additionally, or alternatively, in some examples, the transceiver 1810 may include a wireless transceiver and may communicate bi-directionally with another wireless transceiver. In some examples, the device 1805 may include one or more antennas 1815, which may be capable of transmitting or receiving wireless transmissions (e.g., concurrently). The transceiver 1810 may also include a modem to modulate signals, to provide the modulated signals for transmission (e.g., by one or more antennas 1815, by a wired transmitter), to receive modulated signals (e.g., from one or more antennas 1815, from a wired receiver), and to demodulate signals. The transceiver 1810, or the transceiver 1810 and one or more antennas 1815 or wired interfaces, where applicable, may be an example of a transmitter 1515, a transmitter 1615, a receiver 1510, a receiver 1610, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1825 may include RAM and ROM. The memory 1825 may store computer-readable, computer-executable code 1830 including instructions that, when executed by the processor 1835, cause the device 1805 to perform various functions described herein. The code 1830 may be stored in a non-transitory computer-readable medium such as system memory or another type of memory. In some cases, the code 1830 may not be directly executable by the processor 1835 but may cause a computer (e.g., when compiled and executed) to perform functions described herein. In some cases, the memory 1825 may contain, among other things, a BIOS which may control basic hardware or software operation such as the interaction with peripheral components or devices.

The processor 1835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1835 may be configured to operate a memory array using a memory controller. In some other cases, a memory controller may be integrated into the processor 1835. The processor 1835 may be configured to execute computer-readable instructions stored in a memory (e.g., the memory 1825) to cause the device 1805 to perform various functions (e.g., functions or tasks supporting FDRA for multi-cell scheduling). For example, the device 1805 or a component of the device 1805 may include a processor 1835 and memory 1825 coupled with the processor 1835, the processor 1835 and memory 1825 configured to perform various functions described herein. The processor 1835 may be an example of a cloud-computing platform (e.g., one or more physical nodes and supporting software such as operating systems, virtual machines, or container instances) that may host the functions (e.g., by executing code 1830) to perform the functions of the device 1805.

In some examples, a bus 1840 may support communications of (e.g., within) a protocol layer of a protocol stack. In some examples, a bus 1840 may support communications associated with a logical channel of a protocol stack (e.g., between protocol layers of a protocol stack), which may include communications performed within a component of the device 1805, or between different components of the device 1805 that may be co-located or located in different locations (e.g., where the device 1805 may refer to a system in which one or more of the communications manager 1820, the transceiver 1810, the memory 1825, the code 1830, and the processor 1835 may be located in one of the different components or divided between different components).

In some examples, the communications manager 1820 may manage aspects of communications with a core network 130 (e.g., via one or more wired or wireless backhaul links). For example, the communications manager 1820 may manage the transfer of data communications for client devices, such as one or more UEs 115. In some examples, the communications manager 1820 may manage communications with other network entities 105, and may include a controller or scheduler for controlling communications with UEs 115 in cooperation with other network entities 105. In some examples, the communications manager 1820 may support an X2 interface within an LTE/LTE-A wireless communications network technology to provide communication between network entities 105.

The communications manager 1820 may support wireless communications at a network entity in accordance with examples as disclosed herein. For example, the communications manager 1820 may be configured as or otherwise support a means for transmitting a control message scheduling multi-cell downlink transmissions for a UE over a set of carriers, at least two carriers in the set of carriers being associated with different downlink transmissions of the multi-cell downlink transmissions, the control message indicating FDRA information for a set of RBGs for the at least two carriers in the set of carriers for the multi-cell downlink transmissions. The communications manager 1820 may be configured as or otherwise support a means for transmitting the multi-cell downlink transmissions according to the FDRA information.

By including or configuring the communications manager 1820 in accordance with examples as described herein, the device 1805 may support techniques for scheduling multi-cell downlink transmissions over a set of carriers using separate or a joint FDRA field/indication in the control message (e.g., the scheduling DCI).

In some examples, the communications manager 1820 may be configured to perform various operations (e.g., receiving, obtaining, monitoring, outputting, transmitting) using or otherwise in cooperation with the transceiver 1810, the one or more antennas 1815 (e.g., where applicable), or any combination thereof. Although the communications manager 1820 is illustrated as a separate component, in some examples, one or more functions described with reference to the communications manager 1820 may be supported by or performed by the processor 1835, the memory 1825, the code 1830, the transceiver 1810, or any combination thereof. For example, the code 1830 may include instructions executable by the processor 1835 to cause the device 1805 to perform various aspects of FDRA for multi-cell scheduling as described herein, or the processor 1835 and the memory 1825 may be otherwise configured to perform or support such operations.

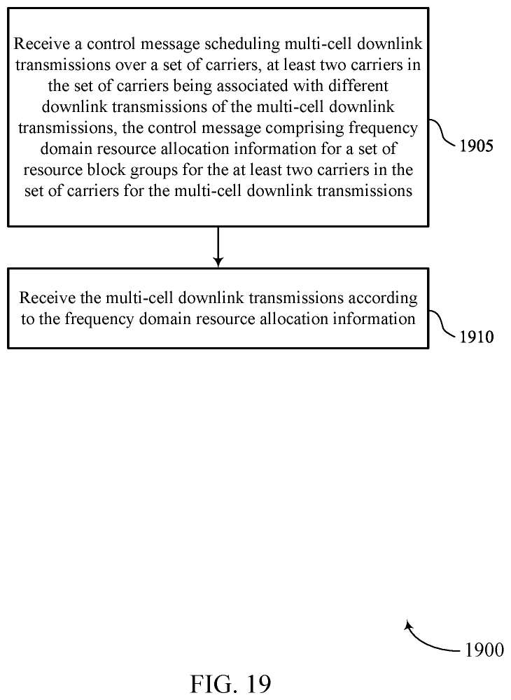

FIG. 19 shows a flowchart illustrating a method 1900 that supports FDRA for multi-cell scheduling in accordance with one or more aspects of the present disclosure. The operations of the method 1900 may be implemented by a UE or its components as described herein. For example, the operations of the method 1900 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1905, the method may include receiving a control message scheduling multi-cell downlink transmissions over a set of carriers, at least two carriers in the set of carriers being associated with different downlink transmissions of the multi-cell downlink transmissions, the control message including FDRA information for a set of RBGs for the at least two carriers in the set of carriers for the multi-cell downlink transmissions. The operations of 1905 may be performed in accordance with examples as disclosed herein. In some examples, aspects of the operations of 1905 may be performed by a grant manager 1325 as described with reference to FIG. 13.

At 1910, the method may include receiving the multi-cell downlink transmissions according to the FDRA information. The operations of 1910 may be performed in accordance with examples as disclosed herein. In some examples, aspects of the operations of 1910 may be performed by a multi-cell downlink transmission manager 1330 as described with reference to FIG. 13.

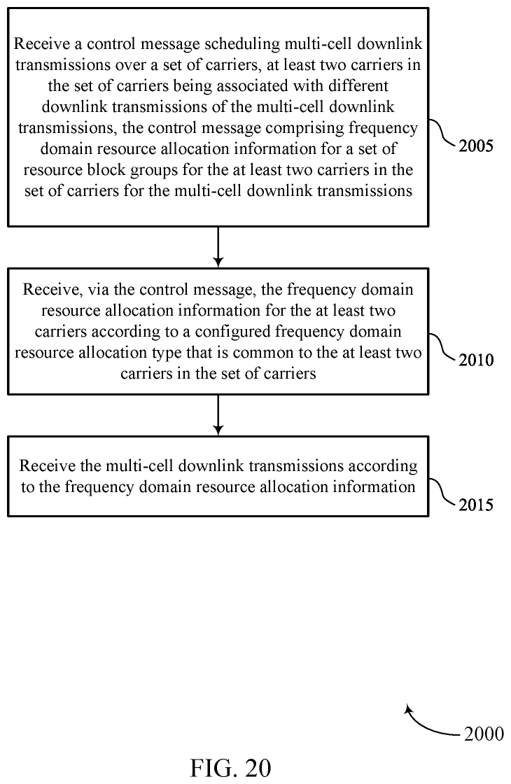

FIG. 20 shows a flowchart illustrating a method 2000 that supports FDRA for multi-cell scheduling in accordance with one or more aspects of the present disclosure. The operations of the method 2000 may be implemented by a UE or its components as described herein. For example, the operations of the method 2000 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 2005, the method may include receiving a control message scheduling multi-cell downlink transmissions over a set of carriers, at least two carriers in the set of carriers being associated with different downlink transmissions of the multi-cell downlink transmissions, the control message including FDRA information for a set of RBGs for the at least two carriers in the set of carriers for the multi-cell downlink transmissions. The operations of 2005 may be performed in accordance with examples as disclosed herein. In some examples, aspects of the operations of 2005 may be performed by a grant manager 1325 as described with reference to FIG. 13.

At 2010, the method may include receiving, via the control message, the FDRA information for the at least two carriers according to a configured FDRA type that is common to the at least two carriers in the set of carriers. The operations of 2010 may be performed in accordance with examples as disclosed herein. In some examples, aspects of the operations of 2010 may be performed by an FDRA type manager 1335 as described with reference to FIG. 13.

At 2015, the method may include receiving the multi-cell downlink transmissions according to the FDRA information. The operations of 2015 may be performed in accordance with examples as disclosed herein. In some examples, aspects of the operations of 2015 may be performed by a multi-cell downlink transmission manager 1330 as described with reference to FIG. 13.

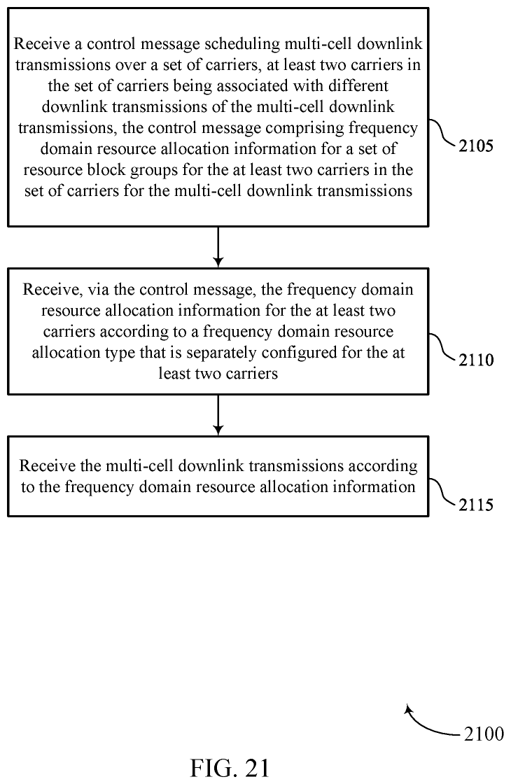

FIG. 21 shows a flowchart illustrating a method 2100 that supports FDRA for multi-cell scheduling in accordance with one or more aspects of the present disclosure. The operations of the method 2100 may be implemented by a UE or its components as described herein. For example, the operations of the method 2100 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 2105, the method may include receiving a control message scheduling multi-cell downlink transmissions over a set of carriers, at least two carriers in the set of carriers being associated with different downlink transmissions of the multi-cell downlink transmissions, the control message including FDRA information for a set of RBGs for the at least two carriers in the set of carriers for the multi-cell downlink transmissions. The operations of 2105 may be performed in accordance with examples as disclosed herein. In some examples, aspects of the operations of 2105 may be performed by a grant manager 1325 as described with reference to FIG. 13.

At 2110, the method may include receiving, via the control message, the FDRA information for the at least two carriers according to a FDRA type that is separately configured for the at least two carriers. The operations of 2110 may be performed in accordance with examples as disclosed herein. In some examples, aspects of the operations of 2110 may be performed by an FDRA type manager 1335 as described with reference to FIG. 13.

At 2115, the method may include receiving the multi-cell downlink transmissions according to the FDRA information. The operations of 2115 may be performed in accordance with examples as disclosed herein. In some examples, aspects of the operations of 2115 may be performed by a multi-cell downlink transmission manager 1330 as described with reference to FIG. 13.

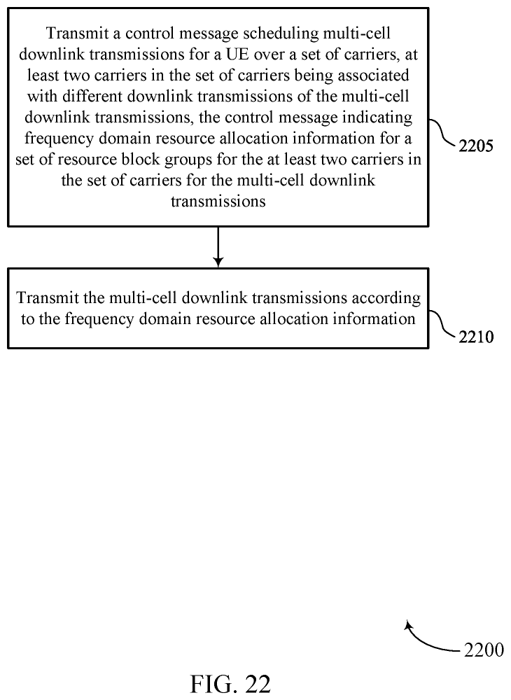

FIG. 22 shows a flowchart illustrating a method 2200 that supports FDRA for multi-cell scheduling in accordance with one or more aspects of the present disclosure. The operations of the method 2200 may be implemented by a network entity or its components as described herein. For example, the operations of the method 2200 may be performed by a network entity as described with reference to FIGS. 1 through 10 and 15 through 18. In some examples, a network entity may execute a set of instructions to control the functional elements of the network entity to perform the described functions. Additionally, or alternatively, the network entity may perform aspects of the described functions using special-purpose hardware.

At 2205, the method may include transmitting a control message scheduling multi-cell downlink transmissions for a UE over a set of carriers, at least two carriers in the set of carriers being associated with different downlink transmissions of the multi-cell downlink transmissions, the control message indicating FDRA information for a set of RBGs for the at least two carriers in the set of carriers for the multi-cell downlink transmissions. The operations of 2205 may be performed in accordance with examples as disclosed herein. In some examples, aspects of the operations of 2205 may be performed by a grant manager 1725 as described with reference to FIG. 17.

At 2210, the method may include transmitting the multi-cell downlink transmissions according to the FDRA information. The operations of 2210 may be performed in accordance with examples as disclosed herein. In some examples, aspects of the operations of 2210 may be performed by a multi-cell downlink transmission manager 1730 as described with reference to FIG. 17.

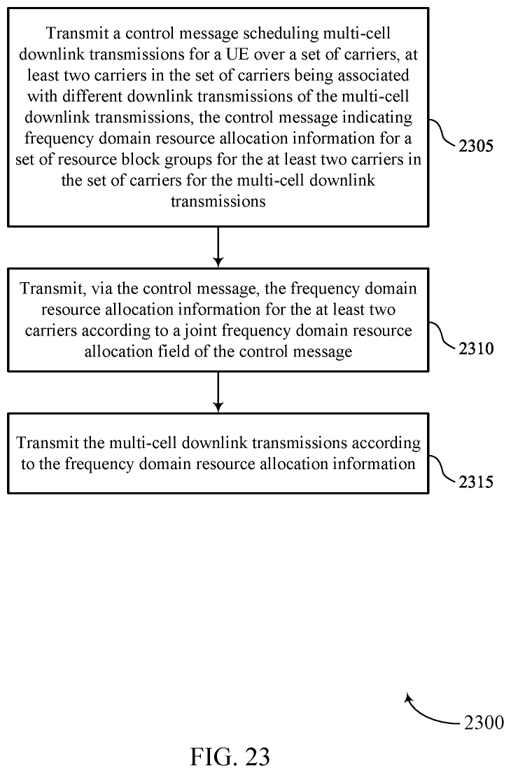

FIG. 23 shows a flowchart illustrating a method 2300 that supports FDRA for multi-cell scheduling in accordance with one or more aspects of the present disclosure. The operations of the method 2300 may be implemented by a network entity or its components as described herein. For example, the operations of the method 2300 may be performed by a network entity as described with reference to FIGS. 1 through 10 and 15 through 18. In some examples, a network entity may execute a set of instructions to control the functional elements of the network entity to perform the described functions. Additionally, or alternatively, the network entity may perform aspects of the described functions using special-purpose hardware.

At 2305, the method may include transmitting a control message scheduling multi-cell downlink transmissions for a UE over a set of carriers, at least two carriers in the set of carriers being associated with different downlink transmissions of the multi-cell downlink transmissions, the control message indicating FDRA information for a set of RBGs for the at least two carriers in the set of carriers for the multi-cell downlink transmissions. The operations of 2305 may be performed in accordance with examples as disclosed herein. In some examples, aspects of the operations of 2305 may be performed by a grant manager 1725 as described with reference to FIG. 17.

At 2310, the method may include transmitting, via the control message, the FDRA information for the at least two carriers according to a joint FDRA field of the control message. The operations of 2310 may be performed in accordance with examples as disclosed herein. In some examples, aspects of the operations of 2310 may be performed by a joint FDRA manager 1740 as described with reference to FIG. 17.

At 2315, the method may include transmitting the multi-cell downlink transmissions according to the FDRA information. The operations of 2315 may be performed in accordance with examples as disclosed herein. In some examples, aspects of the operations of 2315 may be performed by a multi-cell downlink transmission manager 1730 as described with reference to FIG. 17.

The following provides an overview of aspects of the present disclosure:

Aspect 1: A method for wireless communications at a UE, comprising: receiving a control message scheduling multi-cell downlink transmissions over a set of carriers, at least two carriers in the set of carriers being associated with different downlink transmissions of the multi-cell downlink transmissions, the control message comprising FDRA information for a set of RBGs for the at least two carriers in the set of carriers for the multi-cell downlink transmissions; and receiving the multi-cell downlink transmissions according to the FDRA information.

Aspect 2: The method of aspect 1, further comprising: receiving, via the control message, the FDRA information for the at least two carriers according to a configured FDRA type that is common to the at least two carriers in the set of carriers.

Aspect 3: The method of any of aspects 1 through 2, further comprising: receiving, via the control message, the FDRA information for the at least two carriers according to a FDRA type that is separately configured for the at least two carriers.

Aspect 4: The method of any of aspects 1 through 3, wherein the set of RBGs are associated with a RBG size of at least one of 24, 32, 48, 64, or all resource blocks within a BWP, resource blocks-per-RBG.

Aspect 5: The method of any of aspects 1 through 4, further comprising: receiving, via the control message, the FDRA information for the at least two carriers according to a joint FDRA field of the control message.

Aspect 6: The method of aspect 5, further comprising: identifying a combined bandwidth spanning the set of RBGs for the at least two carriers in the set of carriers; and identifying the set of RBGs for the at least two carriers in the set of carriers based at least in part on the joint FDRA field of the control message and the combined bandwidth.

Aspect 7: The method of aspect 6, wherein the control message identifies at least one of a starting RBG associated with a first carrier in the set of carriers, a last RBG associated with a last carrier in the set of carriers, or both.

Aspect 8: The method of any of aspects 5 through 7, further comprising: identifying an extended bandwidth exceeding a span of the set of RBGs for the at least two carriers in the set of carriers; and identifying the set of RBGs for the at least two carriers in the set of carriers based at least in part on the joint FDRA field of the control message and the extended bandwidth.

Aspect 9: The method of any of aspects 5 through 8, further comprising: identifying a number of resource blocks associated with the at least two carriers in the set of carriers; and identifying a RBG size for the at least two carriers in the set of carriers based at least in part on the number of resource blocks, wherein the set of RBGs for the at least two carriers in the set of carriers is based at least in part on the RBG size and the number of resource blocks.

Aspect 10: The method of any of aspects 5 through 9, further comprising: receiving an indication of a RBG size for the at least two carriers in the set of carriers.

Aspect 11: The method of any of aspects 1 through 10, further comprising: determining, based at least in part on the FDRA information in the control message, a common resource allocation bandwidth to be applied across the at least two carriers in the set of carriers, wherein the common resource allocation bandwidth defines an extended bandwidth spanning the at least two carriers and one or more gap resource blocks between the at least two carriers.

Aspect 12: The method of aspect 11, wherein the common resource allocation bandwidth comprises a fractional resource block for at least one carrier in the set of carriers.

Aspect 13: A method for wireless communications at a network entity, comprising: transmitting a control message scheduling multi-cell downlink transmissions for a UE over a set of carriers, at least two carriers in the set of carriers being associated with different downlink transmissions of the multi-cell downlink transmissions, the control message indicating FDRA information for a set of RBGs for the at least two carriers in the set of carriers for the multi-cell downlink transmissions; and transmitting the multi-cell downlink transmissions according to the FDRA information.

Aspect 14: The method of aspect 13, further comprising: transmitting, via the control message, the FDRA information for the at least two carriers according to a configured FDRA type that is common to the at least two carriers in the set of carriers.

Aspect 15: The method of any of aspects 13 through 14, further comprising: transmitting, via the control message, the FDRA information for the at least two carriers according to a FDRA type that is separately configured for the at least two carriers in the set of carriers.

Aspect 16: The method of any of aspects 13 through 15, wherein the set of RBGs are associated with a RBG size of at least one of 24, 32, 48, 64, or all resource blocks within a BWP, resource blocks-per-RBG, or a combination thereof.

Aspect 17: The method of any of aspects 13 through 16, further comprising: transmitting, via the control message, the FDRA information for the at least two carriers according to a joint FDRA field of the control message.

Aspect 18: The method of aspect 17, further comprising: identifying a combined bandwidth spanning the set of RBGs for the at least two carriers in the set of carriers; and identifying the set of RBGs for the at least two carriers in the set of carriers based at least in part on the joint FDRA field of the control message and the combined bandwidth.

Aspect 19: The method of aspect 18, wherein the control message identifies at least one of a starting RBG associated with a first carrier in the set of carriers, a last RBG associated with a last carrier in the set of carriers, or both.

Aspect 20: The method of any of aspects 17 through 19, further comprising: identifying an extended bandwidth exceeding a span of the set of RBGs for the at least two carriers in the set of carriers; and identifying the set of RBGs for the at least two carriers in the set of carriers based at least in part on the joint FDRA field of the control message and the extended bandwidth.

Aspect 21: The method of any of aspects 17 through 20, further comprising: transmitting an indication of a RBG size for the at least two carriers in the set of carriers, wherein the set of RBGs for the at least two carriers in the set of carriers is further based at least in part on the RBG size for the at least two carriers and a number of resource blocks associated with the at least two carriers in the set of carriers.

Aspect 22: The method of any of aspects 17 through 21, further comprising: identifying a number of resource blocks associated with the at least two carriers in the set of carriers; and identifying a RBG size for the at least two carriers in the set of carriers based at least in part on the number of resource blocks associated with the at least two carriers, wherein the set of RBGs for the at least two carriers in the set of carriers is further based at least in part on the RBG size for the at least two carriers in the set of carriers.

Aspect 23: The method of any of aspects 13 through 22, further comprising: determining, based at least in part on the FDRA information in the control message, a common resource allocation bandwidth to be applied across the at least two carriers in the set of carriers, wherein the common resource allocation bandwidth defines an extended bandwidth spanning the at least two carriers and one or more gap resource blocks between the at least two carriers.

Aspect 24: The method of aspect 23, wherein the common resource allocation bandwidth comprises a fractional resource block for at least one carrier in the set of carriers.

Aspect 25: An apparatus for wireless communications at a UE, comprising a processor; memory coupled with the processor; and instructions stored in the memory and executable by the processor to cause the apparatus to perform a method of any of aspects 1 through 12.

Aspect 26: An apparatus for wireless communications at a UE, comprising at least one means for performing a method of any of aspects 1 through 12.

Aspect 27: A non-transitory computer-readable medium storing code for wireless communications at a UE, the code comprising instructions executable by a processor to perform a method of any of aspects 1 through 12.

Aspect 28: An apparatus for wireless communications at a network entity, comprising a processor; memory coupled with the processor; and instructions stored in the memory and executable by the processor to cause the apparatus to perform a method of any of aspects 13 through 24.

Aspect 29: An apparatus for wireless communications at a network entity, comprising at least one means for performing a method of any of aspects 13 through 24.

Aspect 30: A non-transitory computer-readable medium storing code for wireless communications at a network entity, the code comprising instructions executable by a processor to perform a method of any of aspects 13 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive a control message scheduling multi-cell downlink transmissions over a set of carriers, at least two carriers in the set of carriers being associated with different downlink transmissions of the multi-cell downlink transmissions, the control message comprising frequency domain resource allocation information for a set of resource block groups for the at least two carriers in the set of carriers for the multi-cell downlink transmissions; and
receive the multi-cell downlink transmissions according to the frequency domain resource allocation information.

2. The apparatus of claim 1, wherein the instructions are further executable by the processor to cause the apparatus to:
receive, via the control message, the frequency domain resource allocation information for the at least two carriers according to a configured frequency domain resource allocation type that is common to the at least two carriers in the set of carriers.

3. The apparatus of claim 1, wherein the instructions are further executable by the processor to cause the apparatus to:
receive, via the control message, the frequency domain resource allocation information for the at least two carriers according to a frequency domain resource allocation type that is separately configured for the at least two carriers.

4. The apparatus of claim 1, wherein the set of resource block groups are associated with a resource block group size of at least one of 24, 32, 48, 64, or all resource blocks within a bandwidth part (BWP), resource blocks-per-resource block group.

5. The apparatus of claim 1, wherein the instructions are further executable by the processor to cause the apparatus to:
receive, via the control message, the frequency domain resource allocation information for the at least two carriers according to a joint frequency domain resource allocation field of the control message.

6. The apparatus of claim 5, wherein the instructions are further executable by the processor to cause the apparatus to:
identify a combined bandwidth spanning the set of resource block groups for the at least two carriers in the set of carriers; and
identify the set of resource block groups for the at least two carriers in the set of carriers based at least in part on the joint frequency domain resource allocation field of the control message and the combined bandwidth.

7. The apparatus of claim 6, wherein the control message identifies at least one of a starting resource block group associated with a first carrier in the set of carriers, a last resource block group associated with a last carrier in the set of carriers, or both.

8. The apparatus of claim 5, wherein the instructions are further executable by the processor to cause the apparatus to:
identify an extended bandwidth exceeding a span of the set of resource block groups for the at least two carriers in the set of carriers; and
identify the set of resource block groups for the at least two carriers in the set of carriers based at least in part on the joint frequency domain resource allocation field of the control message and the extended bandwidth.

9. The apparatus of claim 5, wherein the instructions are further executable by the processor to cause the apparatus to:
identify a number of resource blocks associated with the at least two carriers in the set of carriers; and
identify a resource block group size for the at least two carriers in the set of carriers based at least in part on the number of resource blocks, wherein the set of resource block groups for the at least two carriers in the set of carriers is based at least in part on the resource block group size and the number of resource blocks.

10. The apparatus of claim 5, wherein the instructions are further executable by the processor to cause the apparatus to:
receive an indication of a resource block group size for the at least two carriers in the set of carriers.

11. The apparatus of claim 1, wherein the instructions are further executable by the processor to cause the apparatus to:
determine, based at least in part on the frequency domain resource allocation information in the control message, a common resource allocation bandwidth to be applied across the at least two carriers in the set of carriers, wherein the common resource allocation bandwidth defines an extended bandwidth spanning the at least two carriers and one or more gap resource blocks between the at least two carriers.

12. The apparatus of claim 11, wherein the common resource allocation bandwidth comprises a fractional resource block for at least one carrier in the set of carriers.

13. An apparatus for wireless communications at a network entity, comprising:
a processor;
memory coupled with the processor; and
instructions stored in the memory and executable by the processor to cause the apparatus to:
transmit a control message scheduling multi-cell downlink transmissions for a user equipment (UE) over a set of carriers, at least two carriers in the set of carriers being associated with different downlink transmissions of the multi-cell downlink transmissions, the control message indicating frequency domain resource allocation information for a set of resource block groups for the at least two carriers in the set of carriers for the multi-cell downlink transmissions; and
transmit the multi-cell downlink transmissions according to the frequency domain resource allocation information.

14. The apparatus of claim 13, wherein the instructions are further executable by the processor to cause the apparatus to:
transmit, via the control message, the frequency domain resource allocation information for the at least two carriers according to a configured frequency domain resource allocation type that is common to the at least two carriers in the set of carriers.

15. The apparatus of claim 13, wherein the instructions are further executable by the processor to cause the apparatus to:
transmit, via the control message, the frequency domain resource allocation information for the at least two carriers according to a frequency domain resource allocation type that is separately configured for the at least two carriers in the set of carriers.

16. The apparatus of claim 13, wherein the set of resource block groups are associated with a resource block group size of at least one of 24, 32, 48, 64, or all resource blocks within a bandwidth part (BWP), resource blocks-per-resource block group, or a combination thereof.

17. The apparatus of claim 13, wherein the instructions are further executable by the processor to cause the apparatus to:
transmit, via the control message, the frequency domain resource allocation information for the at least two carriers according to a joint frequency domain resource allocation field of the control message.

18. The apparatus of claim 17, wherein the instructions are further executable by the processor to cause the apparatus to:
identify a combined bandwidth spanning the set of resource block groups for the at least two carriers in the set of carriers; and
identify the set of resource block groups for the at least two carriers in the set of carriers based at least in part on the joint frequency domain resource allocation field of the control message and the combined bandwidth.

19. The apparatus of claim 18, wherein the control message identifies at least one of a starting resource block group associated with a first carrier in the set of carriers, a last resource block group associated with a last carrier in the set of carriers, or both.

20. The apparatus of claim 17, wherein the instructions are further executable by the processor to cause the apparatus to:
identify an extended bandwidth exceeding a span of the set of resource block groups for the at least two carriers in the set of carriers; and
identify the set of resource block groups for the at least two carriers in the set of carriers based at least in part on the joint frequency domain resource allocation field of the control message and the extended bandwidth.

21. The apparatus of claim 17, wherein the instructions are further executable by the processor to cause the apparatus to:
transmit an indication of a resource block group size for the at least two carriers in the set of carriers, wherein the set of resource block groups for the at least two carriers in the set of carriers is further based at least in part on the resource block group size for the at least two carriers and a number of resource blocks associated with the at least two carriers in the set of carriers.

22. The apparatus of claim 17, wherein the instructions are further executable by the processor to cause the apparatus to:
identify a number of resource blocks associated with the at least two carriers in the set of carriers; and
identify a resource block group size for the at least two carriers in the set of carriers based at least in part on the number of resource blocks associated with the at least two carriers, wherein the set of resource block groups for the at least two carriers in the set of carriers is further based at least in part on the resource block group size for the at least two carriers in the set of carriers.

23. The apparatus of claim 13, wherein the instructions are further executable by the processor to cause the apparatus to:
determine, based at least in part on the frequency domain resource allocation information in the control message, a common resource allocation bandwidth to be applied across the at least two carriers in the set of carriers, wherein the common resource allocation bandwidth defines an extended bandwidth spanning the at least two carriers and one or more gap resource blocks between the at least two carriers.

24. The apparatus of claim 23, wherein the common resource allocation bandwidth comprises a fractional resource block for at least one carrier in the set of carriers.

25. A method for wireless communications at a user equipment (UE), comprising:
receiving a control message scheduling multi-cell downlink transmissions over a set of carriers, at least two carriers in the set of carriers being associated with different downlink transmissions of the multi-cell downlink transmissions, the control message comprising frequency domain resource allocation information for a set of resource block groups for the at least two carriers in the set of carriers for the multi-cell downlink transmissions; and
receiving the multi-cell downlink transmissions according to the frequency domain resource allocation information.

26. The method of claim 25, further comprising:
receiving, via the control message, the frequency domain resource allocation information for the at least two carriers according to a configured frequency domain resource allocation type that is common to the at least two carriers in the set of carriers.

27. The method of claim 25, further comprising:
receiving, via the control message, the frequency domain resource allocation information for the at least two carriers according to a frequency domain resource allocation type that is separately configured for the at least two carriers.

28. The method of claim 25, wherein the set of resource block groups are associated with a resource block group size of at least one of 24, 32, 48, 64, or all resource blocks within a bandwidth part (BWP), resource blocks-per-resource block group.

29. The method of claim 25, further comprising:
receiving, via the control message, the frequency domain resource allocation information for the at least two carriers according to a joint frequency domain resource allocation field of the control message.

30. A method for wireless communications at a network entity, comprising:
transmitting a control message scheduling multi-cell downlink transmissions for a user equipment (UE) over a set of carriers, at least two carriers in the set of carriers being associated with different downlink transmissions of the multi-cell downlink transmissions, the control message indicating frequency domain resource allocation information for a set of resource block groups for the at least two carriers in the set of carriers for the multi-cell downlink transmissions; and
transmitting the multi-cell downlink transmissions according to the frequency domain resource allocation information.
